(19) United States
(12) Patent Application Publication
(10) Pub. No.: US 2013/0035947 A1
(43) Pub. Date: Feb. 7, 2013

(54) CLAIMS PAYOUT SIMULATOR

(71) Applicants: Sudhir Hulikunte Sundararam, Bangalore (IN); Eswaraiah Avvaru, Bangalore (IN); Indrajeet Annasaheb Ketkale, Pune (IN); Mathew George, Bangalore (IN)

(72) Inventors: Sudhir Hulikunte Sundararam, Bangalore (IN); Eswaraiah Avvaru, Bangalore (IN); Indrajeet Annasaheb Ketkale, Pune (IN); Mathew George, Bangalore (IN)

(73) Assignee: Infosys Limited, Bangalore (IN)

(21) Appl. No.: 13/315,172

(22) Filed: Dec. 8, 2011

(30) Foreign Application Priority Data
Aug. 1, 2011 (IN) 2631/CHE/2011

(51) Int. Cl. G06Q 50/22

(52) U.S. Cl. 705/2

(57) ABSTRACT

Disclosed herein are representative embodiments of technologies that can be used to generate medical-claims simulations that can provide information about medical claims. In one exemplary embodiment disclosed herein, medical claims data is received, and a dynamic questionnaire is output. Selections of questionnaire options are received, and based on the medical claims data and the selection of the questionnaire options, at least one medical-claims simulation is generated. The dynamic questionnaire can be driven by user interaction and can enable users of the system to select, validate, and filter data, which can then be submitted for payment and mapping analysis.

### BACKGROUND

Health care providers have used various coding systems to code information relating to patients and medical services rendered to patients. Often, health care providers use a standard set of coding systems to code medical information to receive payment for medical claims from a payer of medical claims such as Medicare. Coded medical data such as Diagnosis-Related Group (DRG) codes are often used by payers of medical claims to determine an amount to pay for a billed medical claim based on a payment system. As health care providers frequently use a designated group of coding systems for medical claims, determining payment amounts that should be recovered for medical claims using new coding systems can be difficult for health care providers using traditional tools.

### SUMMARY

In summary, various tools and techniques are disclosed that can be used to generate medical-claims simulations.

In one exemplary implementation disclosed herein, medical claims data is received, and a dynamic questionnaire is output. Selections of questionnaire options are received, and based on the medical claims data and the selection of the questionnaire options, at least one medical-claims simulation is generated.

In another exemplary implementation at least one simulation scenario and medical claims data organized according to a template is received, and the medical claims data is validated. Based on the at least one simulation scenario selection, a dynamic questionnaire is output that includes first questionnaire options. At least one selection of the first questionnaire options are received and based on the selection a questionnaire prompt and second questionnaire options are output. At least one selection of the second questionnaire options are received, and a selection of a pricing model is received. Based at least on the medical claims data and the one or more selections of the first and second questionnaire options, at least one medical-claims simulation is generated.

The dynamic questionnaire can thus be driven by user interaction and can enable users of the system to select, validate, and filter data, which can then be submitted for payment and mapping analysis.

The foregoing and other objects, features, and advantages of the technologies will become more apparent from the following detailed description, which proceeds with reference to the accompanying figures.

### BRIEF DESCRIPTION OF THE DRAWINGS

FIG. 1 is a diagram of an exemplary system for generating a medical-claims simulation.

FIG. 2 is a flowchart of an exemplary method for generating a medical-claims simulation.

FIG. 3A illustrates a view of exemplary medical claims data

FIG. 3B illustrates a view of exemplary medical claims data

FIG. 4 is a schematic diagram of an exemplary dynamic questionnaire.

FIG. 5 illustrates an exemplary dynamic questionnaire.

FIG. 6 is a diagram of an exemplary system for generating a medical-claims simulation.

FIG. 7 is a flowchart of an exemplary method of generating one or more medical-claims simulations.

FIG. 8 is a flow diagram that illustrates simulation claims data being determined from medical claims data.

FIG. 9 illustrates an exemplary user interface for filtering a medical-claims simulation.

FIG. 10 illustrates an exemplary Payment Analysis Report.

FIG. 11 illustrates an exemplary DRG Mapping Analysis Report.

FIG. 12 illustrates an exemplary International Classification of Disease Mapping Analysis Report.

FIG. 13 illustrates an exemplary Composite Mapping Analysis Report.

FIG. 14 illustrates an exemplary International Classification of Diseases Level Payment Distribution Report.

FIG. 15 illustrates an exemplary Major Diagnostic Categories Report.

FIG. 16 illustrates and exemplary Diagnosis-Related Group Mapping Statistics Report.

FIG. 17A illustrates and exemplary questionnaire prompt database table.

FIG. 17B illustrates and exemplary questionnaire option database table.

FIG. 17C illustrates and exemplary questionnaire results database table.

FIG. 17D illustrates and exemplary medical-claims simulation database table.

FIG. 17E illustrates and exemplary simulation scenario database table.

FIG. 18 illustrates an example implementation of a questionnaire options bank.

FIG. 19 illustrates an example implementation of a questionnaire prompt bank.

FIG. 20 illustrates an example implementation of a questionnaire results bank.

FIG. 21A illustrates a view of an exemplary database design.

FIG. 21B illustrates a view of an exemplary database design.

FIG. 21C illustrates a view of an exemplary database design.

FIG. 21D illustrates a view of an exemplary database design.

FIG. 22 is a schematic diagram illustrating a suitable architecture for any of the disclosed embodiments.

FIG. 23 is a schematic diagram illustrating a generalized example of a suitable computing system for any of the disclosed embodiments.

### DETAILED DESCRIPTION

### EXAMPLE 1

### Exemplary System Employing a Combination of the Technologies

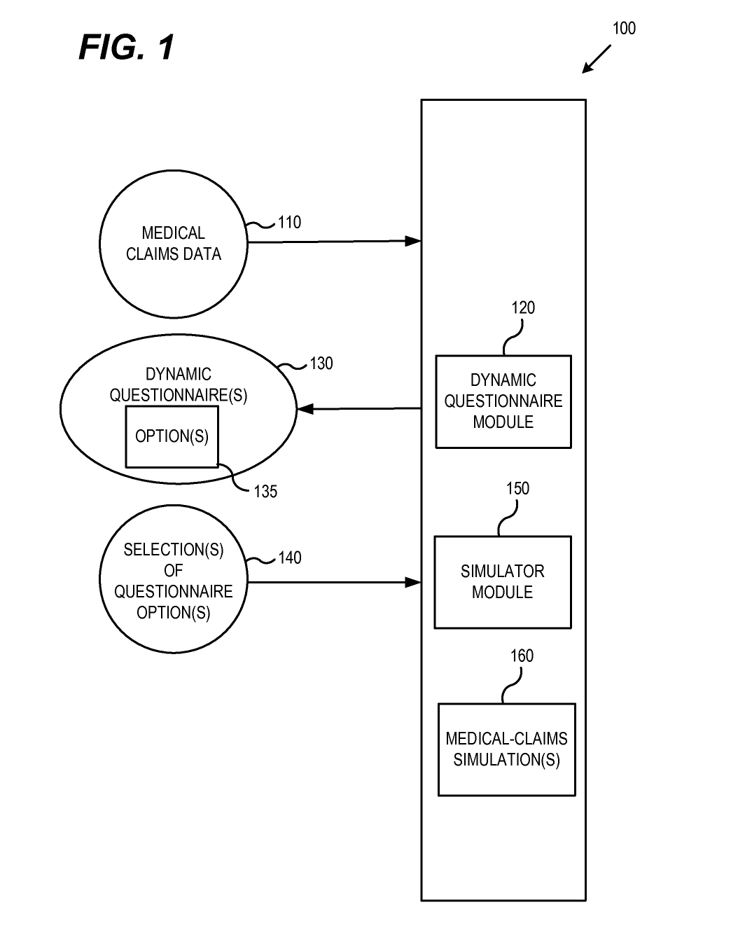

FIG. 1 is a diagram of an exemplary system 100 implementing simulation technologies described herein. In the example, system 100 receives medical claims data 110. For example, the medical claims data can be uploaded to and received by the system 100. The medical claims data can be coded in part according to a coding system. For example, data entries included in the medical claims data can be coded according to a version of an International Classification of Diseases (ICD) coding system or a version of a Disease-Related Group (DRG) coding system, or some other coding system associated with medical claims. The system 100 includes a dynamic questionnaire module 120 for determining and outputting at least one dynamic questionnaire 130. For example, a dynamic questionnaire can be used to collect information from a user to set parameters used in generating a medical-claims simulation. The dynamic questionnaire 130 includes one or more questionnaire options 135. For example, a questionnaire option can be an option for selection by a user. The system 100 can receive one or more selections of questionnaire options 140 provided by the questionnaire module 120. The system 100 also includes a simulator module 150 for generating at least one medical-claims simulation 160 based on the medical claims data 110 and the selections of the questionnaire options 140.

A medical-claims simulation can provide information for health care providers to compare information about claims data coded using one or more new or different coding systems. For example, if a health care provider has used the ICD version 9 and CMS DRG version 23 coding systems in the past and desires to transition to using the newer ICD version 10 and MS DRG version 28 coding systems, a medical-claims simulation can provide information about payout amounts for the medical claims data using the different coding systems. For example, some ICD version 9 codes can map to multiple ICD version 10 codes. So a historical claim (e.g., previously billed claim), that was based on the ICD version 9 code, that was paid a particular amount under a payment system, could be billed based on one or more of the new ICD version 10 codes and possibly be paid different amounts based on the respective new ICD version 10 codes. Also for example, if a health care provider has used the CMS DRG version 23 coding system in the past and desires to transition to using the MS DRG version 28 coding system, a medical-claims simulation can provide information about payout amounts for the medical claims data using the different DRG versions. A medical-claims simulation can be an efficient and useful tool for conveying such information about medical claims. As there are various coding systems used by health care providers and preferred mapping, grouping and other tools and variables to consider in generating a medical-claims simulation, a dynamic questionnaire can efficiently collect data from a user to produce a medical-claims simulation customized based on the users selections. The dynamic questionnaire can thus be driven by user interaction and can enable users of the system to select, validate, and filter data, which can then be submitted for payment and mapping analysis.

The system 100 can provide an automated mechanism to generate information for analyzing a health care provider's financial impact of transitioning from one coding system version to another coding system version based on a questionnaire approach for a simulation scenario.

### EXAMPLE 2

### Exemplary Method of Generating a Medical-Claims Simulation

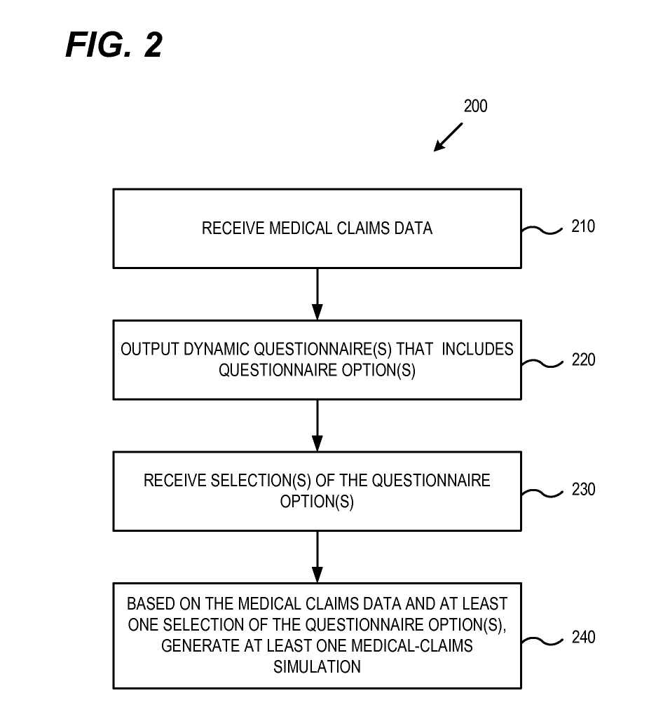

FIG. 2 is a flowchart of an exemplary method 200 for generating one or more medical-claims simulations for a simulation scenario. In the example, medical claims data is received at block 210. For example, medical claims data can include data corresponding to one or more treated patients that can be used to determine payment amounts allowed under a predetermined payment system (e.g., a pricing model) for the health care services provided. The medical claims data can be coded in part according to a coding system. For example, a health care service provider can create claim records for patients that can include one or more ICD codes, DRG codes, MDC codes, or combinations thereof.

At block 220 at least one dynamic questionnaire is output. A dynamic questionnaire can be output based on a simulation scenario. For example, a simulation scenario can determine a desired processing of the medical claims data and desired result of the processing, and the dynamic questionnaire can collect information from a user that can be used to implement the desired processing and result.

In one example, a user may want an analysis of a sub-group of claim records in the data, and the dynamic questionnaire can be used to determine the group of claim records to be processed. In another exemplary implementation, a Payout Analysis Using DRG Simulation Scenario can map ICD codes in a first version of ICD to ICD codes in a different version of ICD as well as map DRG codes in a first version of DRG to DRG codes in a second version of DRG, and generate a payout analysis for claim records based on the second version of DRG. Additionally, the at least one dynamic questionnaire includes one or more questionnaire options for the simulation scenario. For example, the questionnaire options can be output in the dynamic questionnaire for selection by a user to set or store parameters for medical-claims simulation processing.

At block 230 at least one selection of the one or more questionnaire options is received. For example, one or more selections of one or more questionnaire options are received in a user interface from a user and the corresponding simulation parameters are set or stored because of the at least one selection. At block 240, at least one medical-claims simulation is generated based on the medical claims data and the at least one selection of the one or more questionnaire options. For example, the simulation parameters set based on the selection of the questionnaire options can be used with the claims data to determine a medical-claims simulation according to the simulation scenario that includes simulation claims data and/or one or more reports based at least in part on the simulation claims data.

### EXAMPLE 3

### Exemplary Medical Claims Data

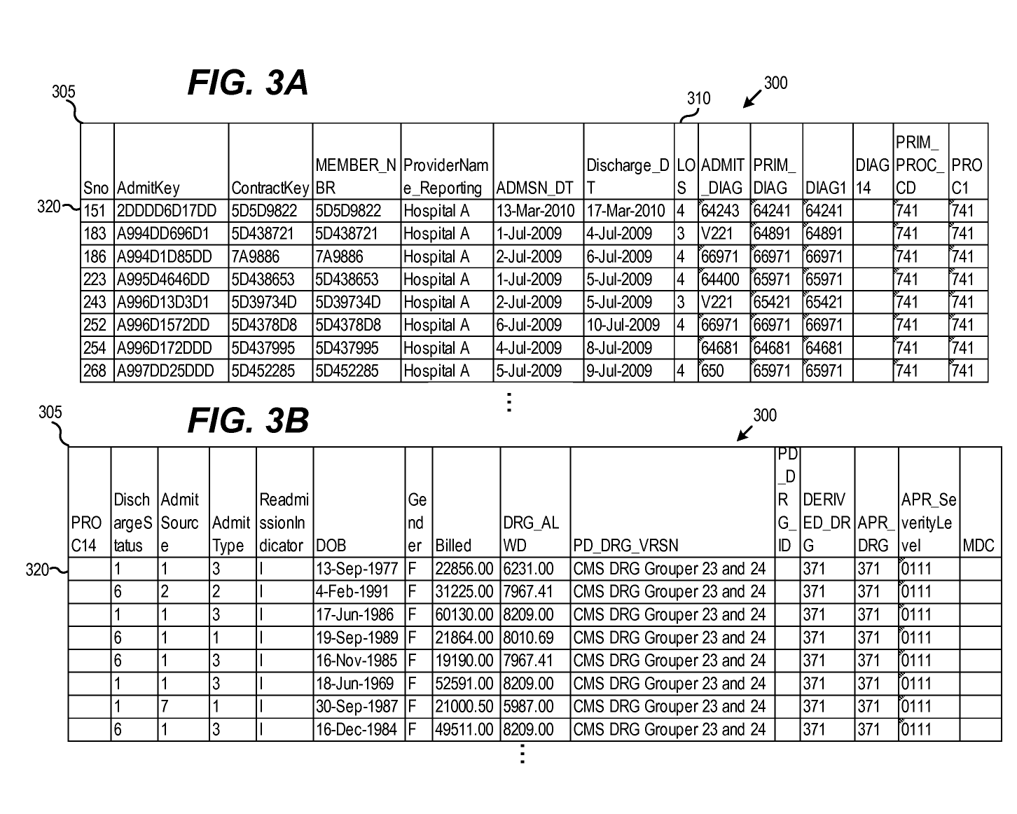

FIGS. 3A-B illustrate exemplary medical claims data 300. The medical claims data 300 includes one or more claim records such as claim record 320. A claim record can include data associated with a medical claim. For example, a health care provider can provide services to a patient and a medical claim record can be kept for the patient that includes data used to recover payment for medical services. Claim records included in the medical claims data can be patient claim records (e.g., historical claim records) or test claim records that include test data that is not data from an actual patient or a combination of both patient claim records and test claim records.

The exemplary medical claims data 300 can be organized according to a predetermined template such as template 305. The template 305 includes template fields that correspond to data included in claim records such as claim record 320. Template field 310 is a length of stay template field that corresponds to data in a claim record for a length of stay of a patient in a provider facility (e.g. hospital). The predetermined template can include fields for one or more pieces of medical claims data that can include an admittance key, a contract key, a member or patient identifier, a healthcare provider identifier, a patient admission date to a provider facility, a patient discharge date from a provider facility, a length of stay of a patient in a provider facility, one or more diagnosis of a patient (e.g., an admittance, primary, or other diagnosis), one or more procedures for a patient (e.g., a primary procedure or other procedure), a discharge status of a patient, an admit source, an admit type, a readmission, a date of birth of the patient, a gender of the patient, a billing amount for the services rendered to the patient, an amount of money allowed for a diagnosis-related group designated for the medical claim, information about a version of DRG used in recovering payment, a DRG code (e.g., a paid DRG code or some other DRG code), paid DRG Identifier Text, a DRG code for the medical claim that is derived, an APR DRG, an APR severity level, an MDC code for the medical claim, or other data related to medical claims.

The medical claims data can be coded at least in part according to one or more coding systems. For example, a claim record for a medical claim can include data for a diagnosis that is coded according to a diagnosis coding system (e.g., an ICD version, or some other diagnosis coding system). Also, the claim record can include data for a procedure that is coded according to a coding system that has codes for procedures, or the claim record can include data for a Diagnosis-Related Group (DRG) that is coded according to a DRG coding system such as DRG version 9 (DRG-9), DRG version 10 (DRG-10), or other DRG version. The claim record can include data for a Major Diagnostic Categories (MDC) code that is coded according to a MDC coding system version. In some examples of medical claims data, the medical claims data can be included in a database or a spreadsheet or some other data organizing technology that can implement a template as described. In some implementations, the medical claims data can be uploaded and stored. For example, medical claims data entered in a database or in a spreadsheet organized according to a template can be uploaded to a computing system that implements one or more of the described technologies herein. In some implementations, the provided medical claims data set can be given a name and a description that can be used for later reference or selection of the stored medical claims data set.

### EXAMPLE 4

### Exemplary Dynamic Questionnaire

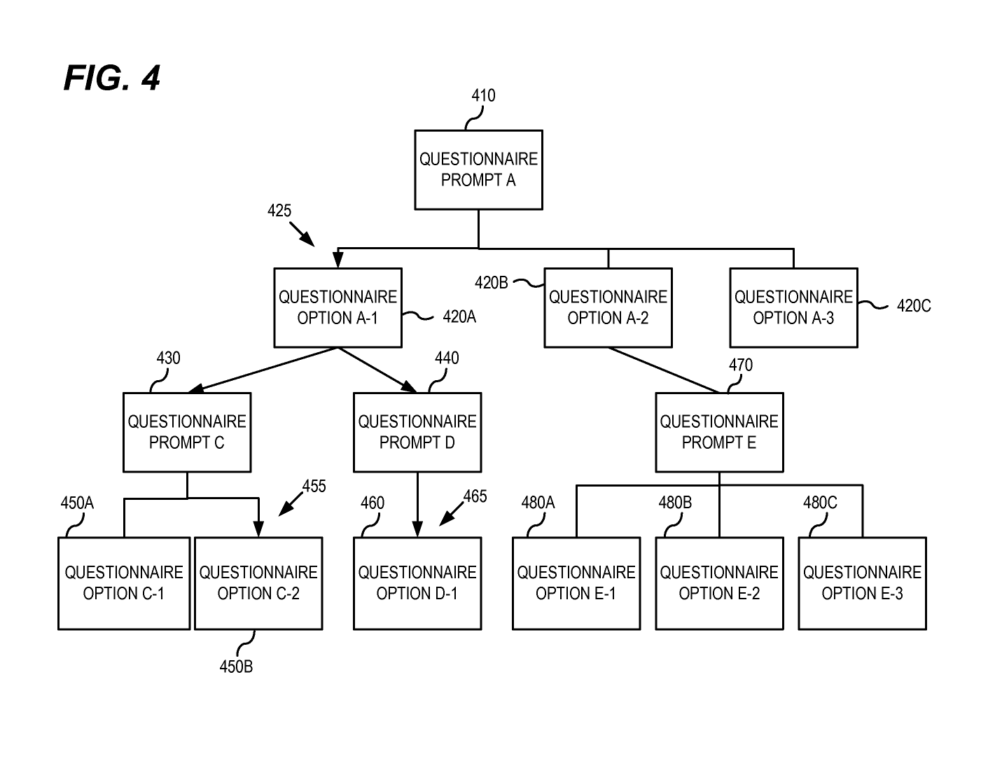

FIG. 4 is a schematic diagram of an exemplary dynamic questionnaire. A dynamic questionnaire can be used to collect information from a user to set parameters used in generating a medical-claims simulation or used in generating one or more dynamic questionnaires. In the example, a questionnaire prompt 410 is output. For example, a questionnaire prompt can display a message (e.g., a question, a statement, or other message) prompting the user to select a questionnaire option associated with the questionnaire prompt. The questionnaire prompt 410 is associated with outputted questionnaire options 420A-C that are selectable. For example, questionnaire options 420A-C can be associated with questionnaire 410 such that when questionnaire 410 is displayed questionnaire options 420A-C are output for display. The questionnaire option 420A is associated with questionnaire prompts 430 and 440 such that if questionnaire option 420A is selected then questionnaire prompts 430 and 440 are output for display. The questionnaire option 420B is associated with questionnaire prompt 450 such that if questionnaire option 420B is selected then questionnaire prompt 450 is output for display. At 425 questionnaire option 420A is selected and an associated simulation parameter is set or stored based on the selection. For example, when the option is selected, because of the selection a medical-claims simulation parameter corresponding to the option is set or stored for use in the generation of the medical-claims simulation. Also because questionnaire option 420A is selected, questionnaire prompts 430 and 440 are displayed. The questionnaire prompts can be output for display at the same time or can be output for display in a sequence. For example, in a sequence, a questionnaire prompt can be displayed before or after another questionnaire prompt. The questionnaire prompt 430 is associated with questionnaire option 450A and questionnaire option 450B such that the questionnaire options are displayed when questionnaire prompt 430 is output. The questionnaire options 450A and 450B are not associated with further questionnaire options that will be displayed if either questionnaire option 450A or 450B is selected. At 455 questionnaire option 450B is selected and an associated medical-claims simulation parameter is set or stored. Because questionnaire option 420A is selected at 425 the questionnaire prompt 440 is output for display along with the associated questionnaire option 460A. The questionnaire prompt 440 is associated with questionnaire option 460A such that if questionnaire prompt 440 is output then questionnaire prompt 440 is output. At 465 questionnaire option 460A is selected and an associated medical-claims simulation parameter is set or stored.

In FIG. 4, the questionnaire options 420B and 420C are not selected. Because questionnaire option 420B is not selected, the questionnaire option prompt 470 is not output and an associated simulation parameter is not set. Because questionnaire prompt 470 is not output the questionnaire options 480A-C are not output for selection.

In some implementations, a dynamic questionnaire includes questionnaire options that are provided without an associated questionnaire prompt. For example, a questionnaire option can be output for display for selection and no associated questionnaire prompt is output for display. Also in other implementations a questionnaire option can be a parent questionnaire option that is associated with one or more dependent questionnaire options such that if the parent questionnaire option is selected then the dependent questionnaire options are output based on the selection. In another implementation when there is a sole questionnaire option associated with a questionnaire prompt that is triggered for outputting, neither the questionnaire prompt nor the questionnaire option is output, and the sole questionnaire prompt is selected for setting a parameter and triggering the outputting of associated questionnaire prompts and options.

In any of the examples herein, information from a previous dynamic questionnaire can be used to generate one or more questionnaire prompts and/or options of a subsequent dynamic questionnaire. For example, a dynamic questionnaire can be output and selections of one or more of its questionnaire options can be selected to set or store parameters used to determine a group of DRG codes filtered from the received medical claims data set based on the selections in the previous dynamic questionnaire. The group of DRG codes can be output as questionnaire options for selection in the subsequent dynamic questionnaire. This type of filtering of DRG codes can be useful to focus processing on a desired group of DRG codes. For example, a user desiring to generate a medical-claims simulation for analysis using claim records that include a derived DRG code for a health care service (e.g., a Caesarean Section, or other service or procedure) can select the corresponding DRG code in a dynamic questionnaire that filtered the DRG codes from the medical claims data based on the previous dynamic questionnaire.

### EXAMPLE 5

### Exemplary Questionnaire Prompt

In any of the examples herein, a questionnaire prompt can be a message prompting a selection of one or more questionnaire options. In some implementations the question prompt prompts a user to select one or more questionnaire options to determine parameters to be used in the generation of a medical-claims simulation or filtered medical-claims simulation.

In one implementation, a questionnaire prompt is a message output to a display using text. The text can be in the form of a question, statement or other sentence or sentence fragment that prompts a user to select a questionnaire option. In one exemplary implementation, understandable and appropriate questions are asked to collect information from a user for setting parameters for simulation. In other implementations, the questionnaire prompt can be output using other methods such as using audio, graphics, or symbols. A questionnaire prompt can be associated with a simulation scenario such that it is output because a simulation scenario is selected.

The questionnaire prompt can be stored in a questionnaire prompt bank (e.g., a database, table, or other data store). A questionnaire prompt can be an independent questionnaire prompt that is output in a dynamic questionnaire and the outputting is not based on a previous questionnaire prompt or questionnaire option. A questionnaire prompt can be a dependent questionnaire prompt that is output in a dynamic questionnaire based on the selection of a questionnaire option or outputted questionnaire prompt. A questionnaire prompt can be a parent questionnaire prompt that is associated with one or more dependent questionnaire options that are output because the questionnaire prompt is output. In some implementations, a questionnaire prompt is not associated with dependent questionnaire prompts or dependent questionnaire options. Questionnaire prompts can be included in dynamic questionnaires used in generating medical-claims simulations or filtered medical-claims simulations.

### EXAMPLE 6

### Exemplary Questionnaire Option

In any of the examples herein, a questionnaire option can be a displayed selectable option. A questionnaire option can be associated with a parameter, such that when the questionnaire option is selected, the parameter can be set for use in generation of a medical-claims simulation or a filtered medical-claims simulation because of the selection. In some implementations, a questionnaire option can be a static questionnaire option. For example, a static questionnaire option can include text or a value that is predetermined and stored in a data store such as a questionnaire option bank (e.g., database, table, or other data store). In some implementations, static questionnaire options can include but are not limited to the option of “True,” “False,” “Yes,” “No”, a predetermined range of values, a flag, or some other value. For example, a range of values for an age could include a value of M years of age to N years of age, where M is the first year of the range and N is the last year of the range.

In other implementations, a questionnaire option can be a dynamic questionnaire option that includes data from provided medical claims data. For example, a data entry, in a claim record, for a field of a template can be included as the text or the value of the dynamic questionnaire option. For example, for a group of dynamic questionnaire options that offer options of health care providers, the health care providers can be determined from template fields in claim records of the provided medical claims data that identify health care providers (e.g., a ProviderName_Reporting field).

Questionnaire options can be selected in a user interface. In some implementations, questionnaire options are selected using a radio button, a drop down list, a data entry box, a check box, selectable text, a hyperlink, or other selection method. A user can select the questionnaire options in a user interface implemented in a web browser or displayed in a display screen. In one implementation a user can select the questionnaire options in the web based user interface by clicking on the questionnaire options with a mouse or other data input tool.

Questionnaire options can be included in dynamic questionnaires used to collect information for generating medical-claims simulations or filtered medical-claims simulations. Questionnaire options can include data included in the claims data, text, names, identifiers, dates, times, coding system names or identifiers, value ranges, identification codes, keys, or numbers, health care provider identifiers, template field text, and other information corresponding to a parameter that can be set for generating information for a dynamic questionnaire, a medical-claims simulation or a filtered medical-claims simulation.

### EXAMPLE 7

### Example Dynamic Questionnaire

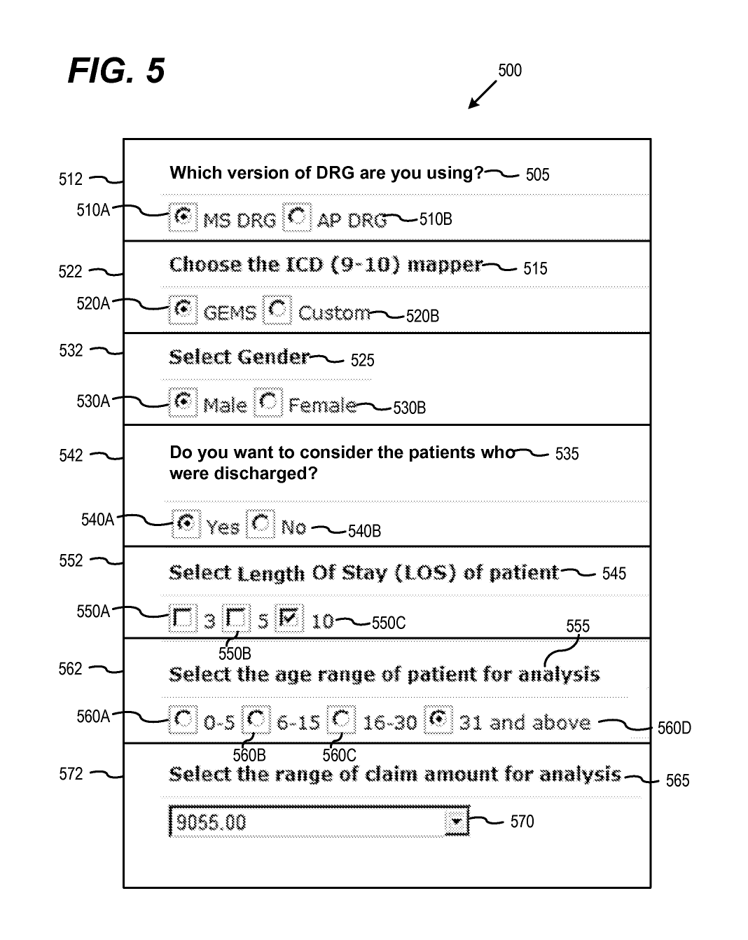

FIG. 5 illustrates an exemplary dynamic questionnaire 500 that can be used to generate a medical-claims simulation. In the figure, the dynamic questionnaire 500 initially displays questionnaire prompt 505 with questionnaire options 510A-B as seen at 512. Questionnaire prompt 505 displays a message to a user in a user interface that asks the user what DRG coding system version is used in coding the claims data provided. The questionnaire prompt 505 is determined as a questionnaire prompt to be displayed based on information in a bank of questionnaire options. For example, the questionnaire prompt 505 is displayed as a predetermined prompt for the scenario and not based on a previous questionnaire option or questionnaire prompt. Questionnaire options 510A-B are associated with and displayed with questionnaire prompt 505. Questionnaire prompt 510A indicates the option of the MS-DRG coding system and questionnaire prompt 510B indicates the option of the AP-DRG coding system. The questionnaire options 510A-B can be associated to be displayed with questionnaire prompt 505 based on information in a bank of questionnaire options. The questionnaire options 510A-B are selectable and can be selected by a user. Questionnaire option 510A is shown as selected by the user. By the selection the user is indicating that the claims data provided by the user is coded using MS-DRG and that information is set or stored as a parameter for use in generating the medical-claims simulation. Because questionnaire option 510A is selected, the dynamic questionnaire is expanded and displays questionnaire prompt 515 and questionnaire options 520A-B as shown at 522. Also, because questionnaire option 510A is selected, the dynamic questionnaire is further extended and questionnaire prompt 525 and questionnaire options 530A-B are displayed as shown at 532. The questionnaire prompts 515 and 525 are associated with questionnaire option 510A and are displayed if questionnaire option 510A is selected.

The questionnaire prompt 515 displays a message prompting a user to choose a desired ICD mapper. The questionnaire options 520A-B indicate the mapper options of the GEM mapper or a custom mapper respectively. The questionnaire option 520A is shown as selected by a user indicating that the GEMS mapper is to be used in mapping from ICD9 to ICD-10 in the generation of the medical-claims simulation and that information is set or stored as a medical-claims simulation parameter for use in generating the medical-claims simulation. The questionnaire prompt 525 displays a message prompting a user to select a gender. The questionnaire options 530A-B indicate the gender options of male and female respectively. The questionnaire option 520A is shown as selected indicating that claim records that include data entries indicating a patient of the male gender are to be used in the generation of the medical-claims simulation and that information is set or stored as a medical-claims simulation parameter for use in generating the medical-claims simulation. Because questionnaire option 520A is selected and there are no questions in the question bank to be displayed if questionnaire option 520A is selected, the dynamic questionnaire is expanded and displays the next questionnaire prompt triggered for output based on the selection of questionnaire option 510A which is questionnaire prompt 535. The questionnaire prompt 535 and its associated questionnaire options 540A-B are displayed as shown at 542. The questionnaire prompt 535 is configured to be displayed if questionnaire option 510A is selected.

The questionnaire prompt 535 displays a message asking if the user wants to consider patients who were discharged, and questionnaire options 540A-B indicate the options of “Yes” and “No” respectively. The questionnaire option 540A is selected indicating that claim records that include data entries indicating a discharged patient are to be processed in generating the medical-claims simulation and that information is set or stored as a simulation parameter for use in generating the medical-claims simulation. Because questionnaire option 540A is selected, the dynamic questionnaire is further expanded and displays questionnaire prompt 545 and questionnaire options 550A-C as shown at 552. The questionnaire prompt 545 displays a message prompting a user to select a patient length of stay, and questionnaire options 550A-C indicate the options of 3 days, 5 days, and 10 days respectively. The questionnaire option 550C is selected indicating that claim records that include data entries indicating a length of stay of 10 days are to be processed in determining the medical-claims simulation.

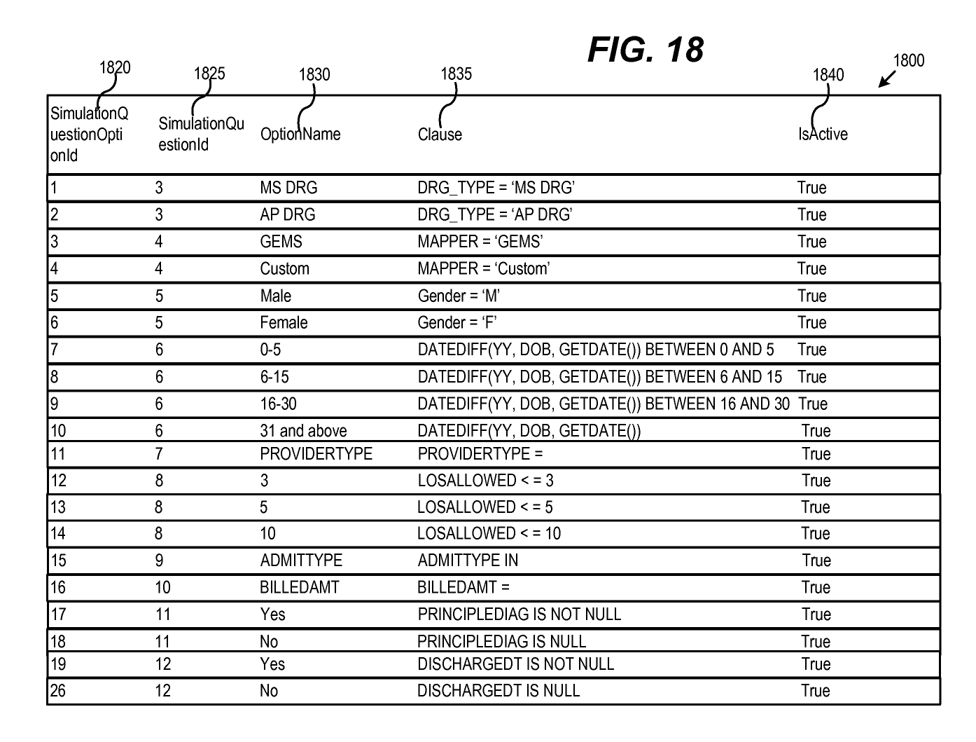

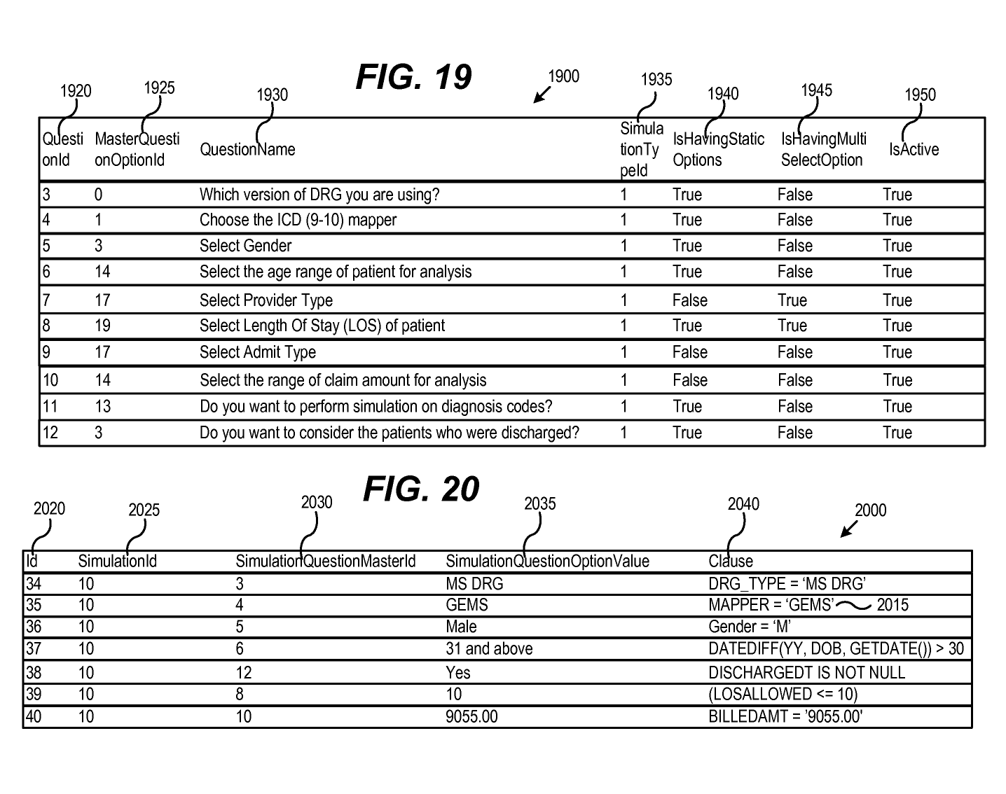

Because questionnaire option 550C is selected, the dynamic questionnaire is further expanded and displays questionnaire prompt 555 and questionnaire options 560A-D as shown at 562, as well as questionnaire prompt 565 and questionnaire options 570 as shown at 572. Both questionnaire prompts 555 and 565 are displayed together because there are no questionnaire prompts that are associated to be output based on the selection of the questionnaire options 560A-D or 570. The questionnaire prompt 555 displays a message prompting a user to select a patient age range for analysis, and questionnaire options 560A-D indicate the options of 0 to 5 years, 6 to 15 years, 16-30 years, and 31 or more years respectively. The questionnaire option 560D is selected indicating that claim records that indicate an age within the range of 31 years or older are to be processed to generate the medical-claims simulation and that information is set or stored as a simulation parameter for use in generating the medical-claims simulation. The questionnaire prompt 565 displays a message prompting the user to select a range for a claim amount to be used for analysis. The questionnaire option 570 is selected which indicates that claim records within data entries indicating a claim amount in the range of up to “9055.00” is to be processed in the generation of the medical-claims simulation, and that information is set or stored as a simulation parameter for use in generating the medical-claims simulation. In one implementation, dynamic questionnaire 500 can be generated using a bank of questionnaire prompts such as illustrated in FIG. 19 and a bank of questionnaire options such as illustrated in FIG. 18.

### EXAMPLE 8

### System Employing a Combination of the Technologies

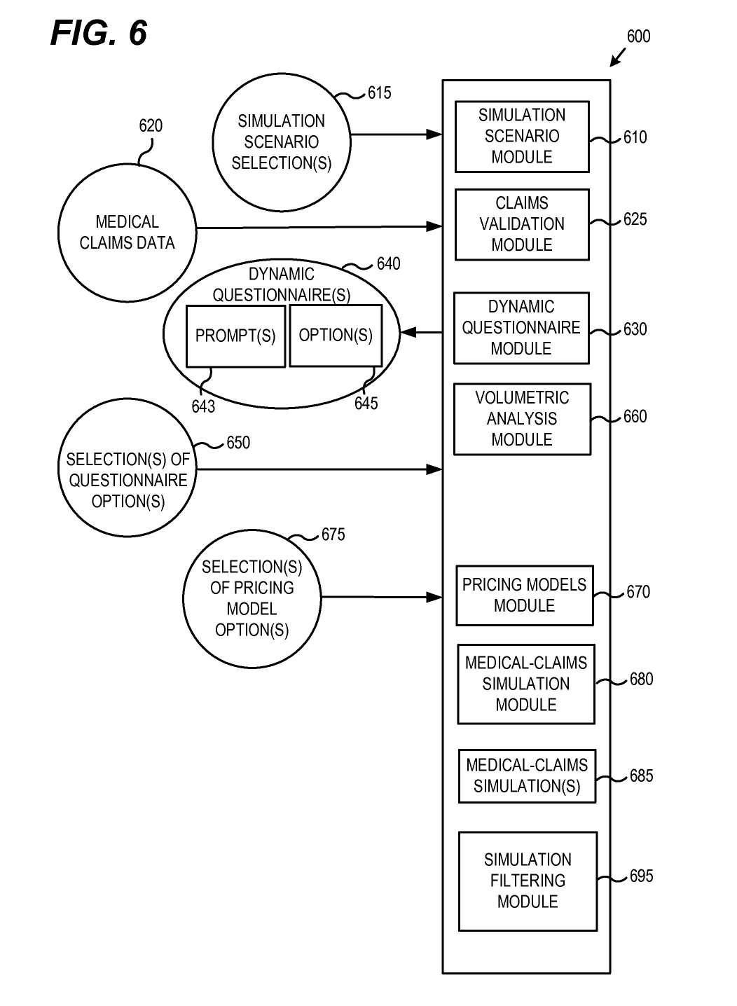

FIG. 6 is a diagram of an exemplary system 600 for generating one or more medical-claims simulations. In the example, system 600 includes a simulation scenario module 610 for providing simulation scenario options for selecting one or more simulation scenarios. A simulation scenario can determine a processing of medical claims data and a resulting medical-claims simulation determined from the processed medical claims data. For example, a simulation scenario can determine that a medical-claims simulation is to be generated using medical claims data. In one example of a simulation scenario, the simulation scenario is a Payout Analysis Using DRG Simulation Scenario which maps ICD codes of one version of ICD to corresponding codes of another version of ICD (e.g., ICD-9 to ICD-10), maps DRG codes of one version of DRG to corresponding codes of another version of DRG (e.g., DRG-9 to DRG-10), and generates a payout analysis based on one or more of the DRG versions in the generation of a medical-claims simulation for the Payout Analysis Using DRG Simulation Scenario. A pricing model that is DRG based is used to produce the Payout Analysis Using DRG simulation scenario.

In another exemplary implementation, a simulation scenario can be a Payout Analysis Using ICD Simulation Scenario. The Payout Analysis Using ICD Simulation Scenario can map ICD codes of one version of ICD to corresponding codes of another version of ICD (e.g., ICD-9 to ICD-10) and generate a payout analysis based on ICD code groupers, which can be automatically identified from uploaded medical claims data, in the generation of a medical claims simulation for the Payout Analysis Using ICD Simulation Scenario. A pricing model that is ICD based (e.g., based on ICD parameters such as ADMIT DIAGNOSIS, PRIMARY DIAGNOSIS, PRINCIPLE PROCEDURE, or other ICD parameters) is used in the Payout Analysis Using ICD Simulation Scenario. Also the medical claims data used in the Payout Analysis Using ICD Simulation Scenario can be outpatient or professional and the processing of the claim records does not use DRG codes received in the medical claims data. Another exemplary simulation scenario is an ICD Mapping Analysis Simulation Scenario that maps ICD codes of one version of ICD to corresponding codes of another version of ICD (e.g., ICD-9 to ICD-10) in generating a medical-claims simulation for the ICD Mapping Analysis Simulation Scenario. A further simulation scenario is a DRG Mapping Analysis Simulation Scenario that maps ICD codes of one version of ICD to corresponding codes of another version of ICD (e.g., ICD-9 to ICD-10) and maps DRG codes of one version of DRG to corresponding codes of another version of DRG (e.g., DRG-9 to DRG-10) in the generation of a medical-claims simulation for the DRG Mapping Analysis Simulation Scenario. Yet another simulation scenario is a MDC Mapping Analysis Simulation Scenario that maps DRG-9 codes to DRG-10 codes, and maps MDC-9 codes to MDC-10 codes in the generation of a medical-claims simulation for the MDC Mapping Analysis Simulation Scenario. In some further implementations a simulation scenario can include a Payout Analysis Using a Length of Stay Simulation Scenario which is based in part on a length of stay of a patient, and a Reverse Mapping and Payment Neutralize Simulation Scenario.

The system 600 receives one or more simulation scenario selections 615. For example, a user selects a simulation scenario option provided in a user interface and the selection is received indicating a selected simulation scenario. Also, the system receives medical claims data 620. The system 600 includes a claims validation module 625 for validating the medical claims data. The system 600 also includes a dynamic questionnaire module for generating and outputting one or more dynamic questionnaires 640. A dynamic questionnaire includes one or more questionnaire prompts 643 and or one or more questionnaire options 645. The system 600 receives one or more selections of questionnaire options 650. The system includes a volumetric analysis module 660 for generating and outputting a volumetric analysis of the claims data. A volumetric analysis can provide information regarding occurrence volume and financial data volume for identified ICD, DRG, and MCD codes. A volumetric analysis can provide information about a frequency and payout amount of ICD, DRG, or MCD codes in medical claim data. A volumetric analysis can be output for display in a chart and can also be output with a chart that includes a time frame (e.g., month or year) trend analysis for the DRGs. In some examples, a user can select filtering options such as questionnaire options based on information provided in a volumetric analysis. The system 600 includes a pricing models module 670 for outputting pricing model options for selection, and the system 600 can receive one or more selections of the pricing model options 675. The one or more selections of the pricing model options 675 can be used to determine a pricing model to be used in medical-claims simulation generation. In some implementations, a pricing model option can be selected as a questionnaire option in a dynamic questionnaire. The system 600 includes one or more medical-claims simulation modules 680 for generating and outputting one or more medical-claims simulations 685. The system 695 also includes a medical-claims simulation filtering module 695 for generating and outputting a filtered medical-claims simulation. The system 600 can provide information for analyzing a health care provider's financial impact of transitioning from one coding system version to another coding system version based on a user interaction driven questionnaire based approach that enables users to select, validate, or filter data, and submit data for payment and mapping analysis.

### EXAMPLE 9

### Exemplary Method of Applying a Combination of the Technologies

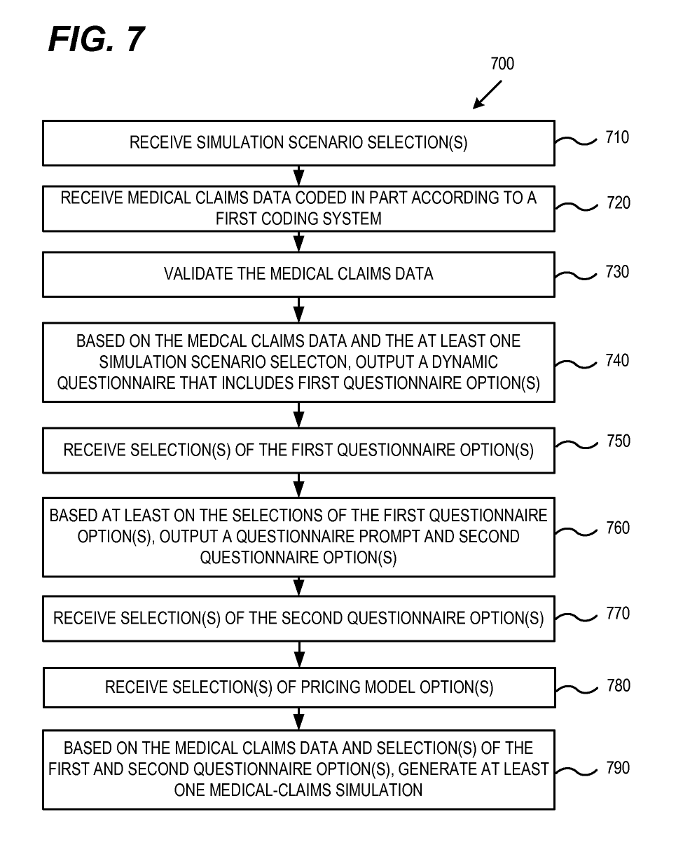

FIG. 7 is a flowchart of an exemplary method 700 of generating one or more medical-claims simulations. In the example, at least one simulation scenario selection is received at 710. For example, simulation scenario options can be output for display in a user interface for selection by a user. The user can select one or more of the provided simulation scenario options and the selection can be received to determine at least one selected simulation scenario. A selected simulation scenario can determine claims records to be processed (e.g., via dynamic questionnaires or other methods), the processing to be done on the claim records, and the type of information (e.g., simulation claims data, and/or reports) generated for a medical-claims simulation. For example, a user can select a provided option of a simulation scenario such as a Payout Analysis Using DRG Simulation Scenario. A Payout Analysis Using DRG Simulation Scenario can generate a medical-claims simulation with information about payouts allowed for claim records for DRG codes of different versions of DRG using a pricing model that is based on DRG codes. At block 720, medical claims data coded in part according to a first coding system is received. For example, medical claims data that includes at least one claim record that includes diagnosis information, procedure information, and/or DRG information coded according to one or more coding systems can be uploaded to a received by a computing system by a user or some other computer system.

At block 730, the medical claims data is validated. For example, the medical claims data is analyzed for possible errors and if one or more errors are identified a notice of the identified errors can be output to the user in a display, so that the user can correct one or more of the identified errors, and/or proceed with medical-claims simulation generation without correcting one or more of the identified errors. A notice of identified errors can be displayed to a user in a user interface. For example, claim records that are identified as including errors in their data can be listed along with corresponding template field identifiers. In one implementation, fields included in claim records that are empty or do not contain appropriate data can be marked in the display. For example the fields can be colored in a particular color (e.g., red), highlighted, or otherwise marked.

In one implementation, a set of rules can be applied to the medical claims data organized according to a predetermined template to analyze the data for errors. An error in the data can be missing data (e.g., no data in a template field expected to have data), an incorrect format, or other error. In some implementations errors in records of the medical claims data can include inappropriate data in fields such as a discharge data field (e.g., having a future data), an allowed amount field (e.g., having a zero amount), a length of stay field (e.g., having a zero value, indicating no length of stay, with procedure codes provided, or having a non-zero value with no procedure codes provided), a bill type field (e.g., having no bill type provided), a paid DRG code field (e.g., having an invalid DRG code), or an ICD diagnosis code field (e.g., having an invalid ICD code). In some implementations errors in the medical claim data can be identified if multiple records have the same claim id or reprocessed claims. In another example, an error can be identified if claims records indicate that on the same date a patient was admitted for 1 day and also visited 20 times with different allowed amounts. In other implementations, errors in the medical claims data can be invalid member or patient data such as and invalid age, or gender. In yet another implementation, if both inpatient and outpatient data are jumbled up (e.g., transposed on mismatched fields) it can be identified as an error.

In some implementations medical claim records that have errors can be downloaded for correction. In other implementations, medical claims data that is corrected can be uploaded, or the data fields that have errors can be corrected in a user interface. In another implementation, if an error identified in the data is not corrected before the generation of a medical-claims simulation, the claim record that includes the missing data or other identified error in data can be ignored or not used in generating a medical-claims simulation. In some implementations, a percentage of claim records without errors (e.g., validated claim records) or claim records with errors (e.g., rejected claim records) can be given.

At block 740, a dynamic questionnaire is output based at least in part on the medical claims data and the at least one scenario selection. The dynamic questionnaire includes one or more first questionnaire options. For example, questionnaire options can be output for display in a user interface for user selection and the questionnaire options can be associated with the simulation scenario selected. For example, a bank of possible questionnaire prompts and options can be determined for a simulation scenario and output based on the scenario being selected. Also, the questionnaire prompts can be based on the medical claims data. For example, the questionnaire prompts that are output can include data provided in the medical claims data. At block 750, at least one selection of the first questionnaire options are received. For example, a user selects one or more of the questionnaire options displayed in the user interface and the selection is received and sets a parameter based on the selection. At block 760, at least one questionnaire prompt and a second questionnaire options are output based at least on the at least one selection of the first questionnaire options. For example, subsequent questionnaire options can be output based on an associated questionnaire prompt that is caused to be output based on the selection of a selected questionnaire option, or the subsequent questionnaire options can be associated with the selected questionnaire option such that the subsequent questionnaire options are output because the selected questionnaire option is selected. At block 770, selections of second questionnaire options are received. For example, a user can make one or more selections of the second questionnaire options displayed in a user interface and the one or more selections are received and associated parameters are set.

At block 780, at least one selection of a pricing model is received. For example, one or more pricing model options can be output in a user interface for selection by a user and the user can make a selection of at least one of the pricing models options which can be received. A selected pricing model option can be used to determine a pricing model to be used in generating one or more medical-claims simulations. The pricing model options outputted can be based on the provided claims data. In some implementations, a pricing model option can be associated with a questionnaire prompt and selected as a questionnaire option in a dynamic questionnaire. At block 790, at least one medical-claims simulation is generated based on the medical claims data and the at least one selection of the first and second questionnaire options. For example, parameters set based on the selection of the first and second questionnaire options can be used in processing the medical claims data in generation a medical-claims simulation appropriate for the at least one selected simulation scenario.

### EXAMPLE 10

### Exemplary Pricing Model

In any of the examples herein, a pricing model can be used to determine allowed payment amounts for medical claims. For example, a health care provider can provide a particular medical health care service to a patient with a particular diagnosis or health care need, and a medical claim for payment can be billed to a medical claims payer. The payment amount allowed by the medical claims payer for the medical service provided to the patient can be predetermined and set in a pricing model. The pricing model relates a payment amount to a medical service for a patient. In one example, a pricing model can be based on DRG codes. In this example, the pricing model associates particular DRG codes with allowed payment amounts for the DRG codes. That is to say, the pricing model designates an amount for payment for a medical claim that is billed for medical services that can be mapped to a particular DRG code. In other implementations pricing models are based on other medical coding systems such as ICD versions. In some implementations, third party or external pricing models can be accessed using web services for use in a system that can generate a medical-claims simulation. In some implementations, pricing models are built-in pricing models that are built in to a system that can produce a medical-claims simulation. Third party, external, built-in pricing models, or other pricing models can be used to generate medical-claims simulations.

### EXAMPLE 11

### Exemplary Coding System

In any of the examples herein, a coding system can be a system for coding medical information or information related to health care services or health care claims. Coding systems include but are not limited to versions of the International Classification of Diseases (ICD) coding system such as the so called ICD version 9 (ICD-9) and ICD version 10 (ICD-10), versions of the Diagnosis-Related Group (DRG) coding system such as the so called DRG version 9 (DRG-9) and DRG version 10 (DRG-10), and versions of the MDC coding system. Diagnosis-Related Group (DRG) versions include Medicare DRG versions such as the Centers for Medicare and Medicaid Services (CMS) DRG versions such as the so called CMS-DRG, the so called MS-DRG versions 25, 26, 27, and 28, AP-DRG, and other DRG versions. Major Diagnostic Code (MDC) versions include version 05, 06, 14, and 15. A coding system can provide a code related to a diagnosis (e.g., ICD code), a procedure, a diagnosis-related group (e.g., DRG code), or other medical information or combinations of medical information.

### EXAMPLE 12

### Example of Determining Simulation Claims Data

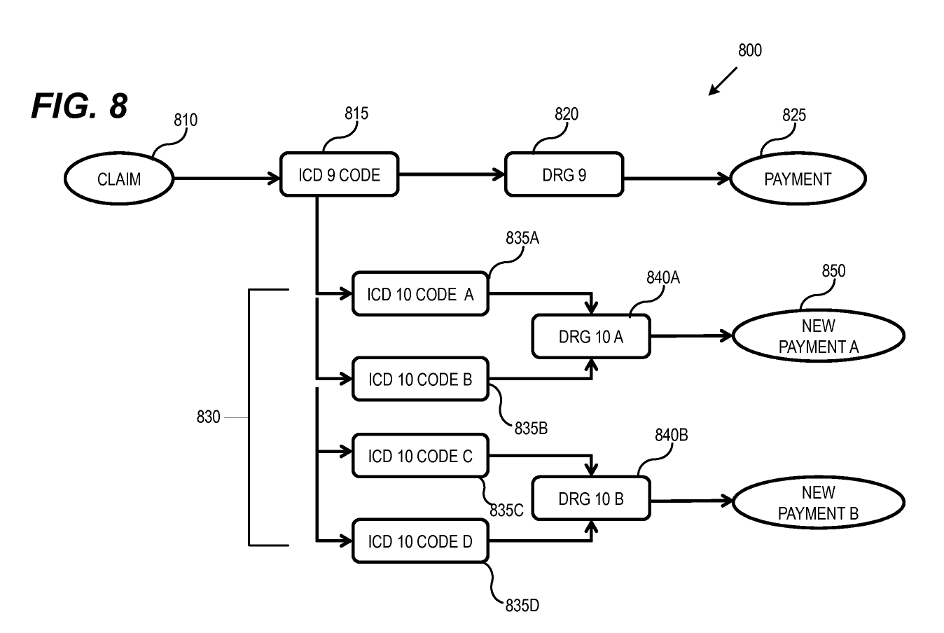

FIG. 8 is a flow diagram that illustrates simulation claims data being determined or derived from medical claims data. In the example, a claim record 810 is received that includes data coded according to a coding system such as diagnosis data 815 that includes diagnosis data that is coded using ICD-9. For example, the medical claims data 810 can be historical data from a medical claim previously created by a healthcare provider and used to receive a payment for medical services based on ICD-9 coding standards. The medical claims data 810 includes DRG data 820 that is a DRG-9 code as derived by a grouper from the medical claims data 810 including the ICD-9 code. A grouper can derive a DRG code at least using an ICD code. For example, given a code corresponding to an ICD coding system and other medical information about a patient and services, a grouper can determine a code in a DRG coding system version that corresponds, according to the DRG coding system version, to the ICD code and other medical information. A grouper can be implemented for determining DRG codes in a particular DRG version from ICD codes in a particular ICD version. The claims data also includes a payment 825 allowed under a pricing model for the DRG code of DRG data 820.

At 830, the diagnosis data 815 is mapped (e.g., at least by using a mapper) to derive some simulation claims data such as the diagnosis data of ICD-10 codes 835A-D. A mapper can determine an ICD code in one version at least using an ICD code in a different version of ICD. The ICD-10 codes correspond to diagnoses that are covered by the ICD-9 code according to the earlier ICD-9 coding system. The ICD-10 codes 835A-D are used to derive (e.g., at least by using a grouper) appropriate Diagnosis-Related Group codes in the DRG-10 coding system using the claim data to derive simulation DRG data such as DRG-10 code 840A and DRG-10 code 840B. The derived DRG-10 codes 840A-B correspond according to a pricing model to derive corresponding simulation payments such as payments 850 and 860 that are allowed under the DRG-10 codes according to the pricing model. For example, DRG-10 code 840A can correspond to a payment such as payment 850 that is allowed according to a pricing model or other medical claim payment system. In some implementations of generated medical-claims simulations, simulation claims data can include data coded according to a version of a coding system derived from medical claims data coded in a different version of the coding system (e.g., derived DRG-10 codes from DRG-9 codes, or derived ICD-10 codes derived from ICD-9 codes), data derived from medical claims data (e.g., ICD, DRG, or MDC codes derived from other ICD, DRG, or MCD codes), and payment information derived from a pricing model that is based on the available medical claims data or derived data coded in the chosen coding system. In some implementations, simulated medical claims data includes but is not limited to derived simulation diagnosis data such as ICD codes, derived simulation DRG data, derived MDC data, derived payment data, or other data derived using the medical claims data.

### EXAMPLE 13

### Exemplary Filtering of a Medical-Claims Simulation

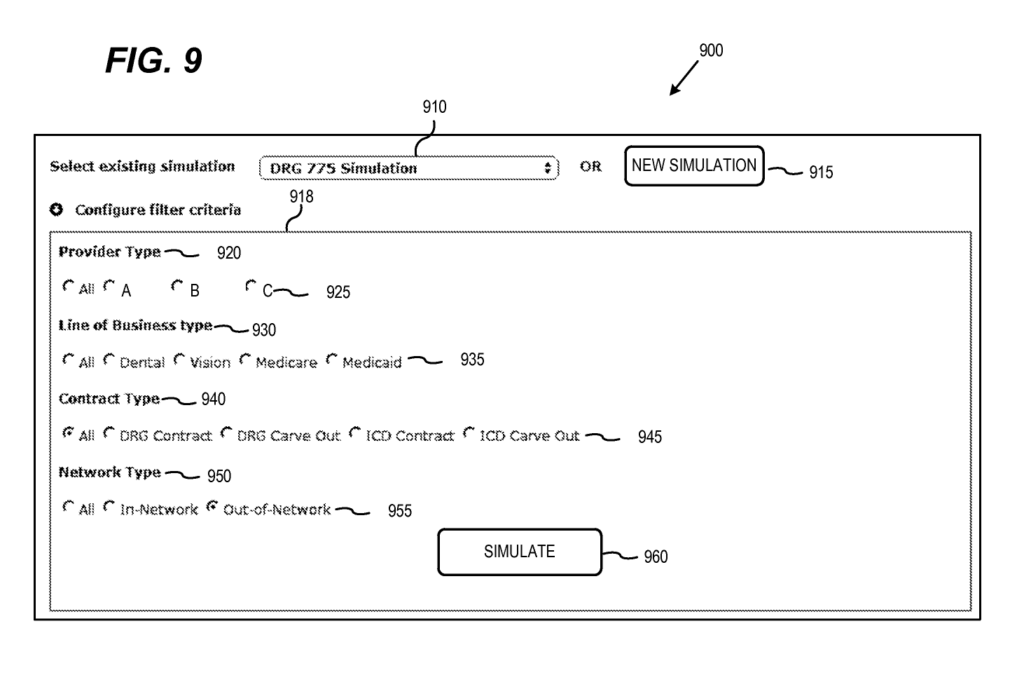

FIG. 9 illustrates an exemplary user interface 900 for filtering a generated medical-claims simulation 910. In the example, the generated medical-claims simulation 910 is selected. Based on the selected medical-claims simulation, the dynamic questionnaire 918 is output for collection of filtering information from a user. The dynamic questionnaire 918 includes questionnaire prompts 920, 930, 940, and 950 with their respective associated questionnaire options 925, 935, 945, and 955. The questionnaire prompts and options output for a generated medical-claims simulation can be simulation questionnaire prompts and simulation questionnaire options. The simulation questionnaire prompts and options that are output can be determined based on medical claims data and simulation data stored for the selected medical-claims simulation. For example, data that is available in the medical-claims simulation and medical claims data can be included in the simulation questionnaire options and can determine what independent questionnaire prompts are output. In the example, a user can select one or more of the simulation questionnaire options to set parameters associated with the simulation questionnaire options. The parameters can be used to filter the data stored (e.g., the simulation claims data and associated processed claims records) for the selected medical-claims simulation. For example, the generated medical-claims simulation can have associated stored medical claims data and includes simulated claims data and associated reports based on the simulated and medical claims data. The parameters set from selected simulation questionnaire options can be used to filter the medical-claims simulation and medical claims data to generate a filtered medical-claims simulation. In one implementation, parameters are set so that conforming claim records and associated simulation claims data can be extracted (e.g., by a database query) for use in generating filtered simulation reports included in the filtered medical-claims simulation. For example, simulation questionnaire options can be output listing health care provider types such as in questionnaire options 925. One or more of the questionnaire options 925 can be selected indicating selected provider types, and claims records with associated simulation claims data that include the selected provider types can be used in generating filtered simulation reports. A user can generate one or more filtered simulation reports by selecting one or more simulation questionnaire options and proceeding with the medical-claims simulation generation or simulation. A user can proceed with the simulation in the example of FIG. 9 by selecting the simulate button 960. Also, a new medical-claims simulation can be generated by a user selecting the new simulation button 915 in the user interface 900.

### EXAMPLE 14

### Exemplary Medical-Claims Simulation

In any of the examples herein, a medical-claims simulation or a filtered medical-claims simulation can include simulation claims data and simulation reports. The simulation reports can include but are not limited to a Payment Analysis Report, Diagnosis-Related Group (DRG) Mapping Analysis Report, an International Classification of Diseases (ICD) Mapping Analysis Report, a Composite Mapping Analysis Report, a Major Diagnostic Categories (MDC) Report, a Diagnosis-Related Group (DRG) Mapping Statistics Report, an International Classification of Diseases (ICD) Level Payment Distribution Report, or a Financial Analysis Report. A medical-claims simulation can be generated based in part on one or more selections of questionnaire options in one or more dynamic questionnaires for a simulation scenario. In one implementation, parameters set from selections of questionnaire options are used to determine claim records of medical claims data to be used in generating simulation claims data and associated simulation reports appropriate for a simulation scenario. The simulation scenario can be selected by a user. In some implementations, the parameters set from selections of questionnaire options determine: a database query for querying a group of claim records of the medical claims data, groupers to be used in determining DRG codes, mappers to be used in determining ICD codes, as well as versions of DRG, ICD, and MDC to be used for generating simulation claims data, and versions of DRG, ICD, and MDC that are used in encoding the medical claims data as well as other information or tools used to generate a medical-claims simulation. In some implementations, the reports can be saved, output, exported (e.g., to a PDF file format or a spreadsheet).

### EXAMPLE 15

### Exemplary Payment Analysis Report

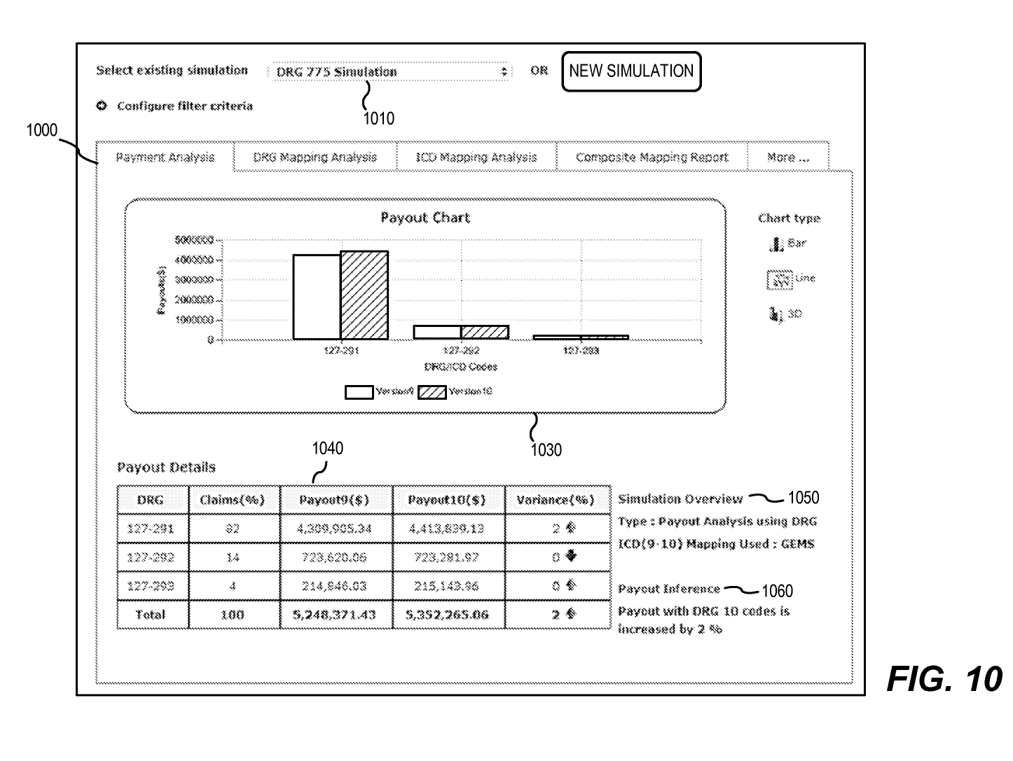

FIG. 10 illustrates an exemplary implementation of a Payment Analysis Report that includes a payout analysis 1030 and a payout details 1040. In one implementation, the payout analysis provides information about a total payout amount for the combination of claim records processed in the medical-claims simulation generation that have associated DRG codes in a designated version of DRG and/or ICD codes in a designated version of ICD. Also the payout analysis provides information about a total payout amount for the combination of claim records that have associated DRG codes of a different version of DRG and/or ICD codes of a different version of ICD. The payout analysis can provide information to a user about how much money a health care provider receives for a particular claim set under an earlier version of ICD, or DRG as compared to a different or later version of ICD or DRG. In some implementations, the payout analysis can be output in textual data, or in a chart such as a bar, line, or three-dimensional chart.

In one implementation, the payout details 1040 includes a detailed payout summary to the user. The payout details include an original DRG code and a derived DRG code, a percentage of the processed claim records that are associated with those DRG codes, the payment amount allowed for the claims records associated with the DRG codes in both an original and different versions of DRG, and an indicator of a percent of variance between the two payout amounts. The payout details can also show as simulation overview 1050 that identifies the selected simulation scenario and the mapper used in the medical-claims simulation generation. The payout details can provide a payout inference 1060 that shows a percentage of variance between the payout amounts for the claim records processed under a DRG version as compared to the different DRG version used in the report.

### EXAMPLE 16

### Exemplary Diagnosis-Related Group Mapping Analysis Report

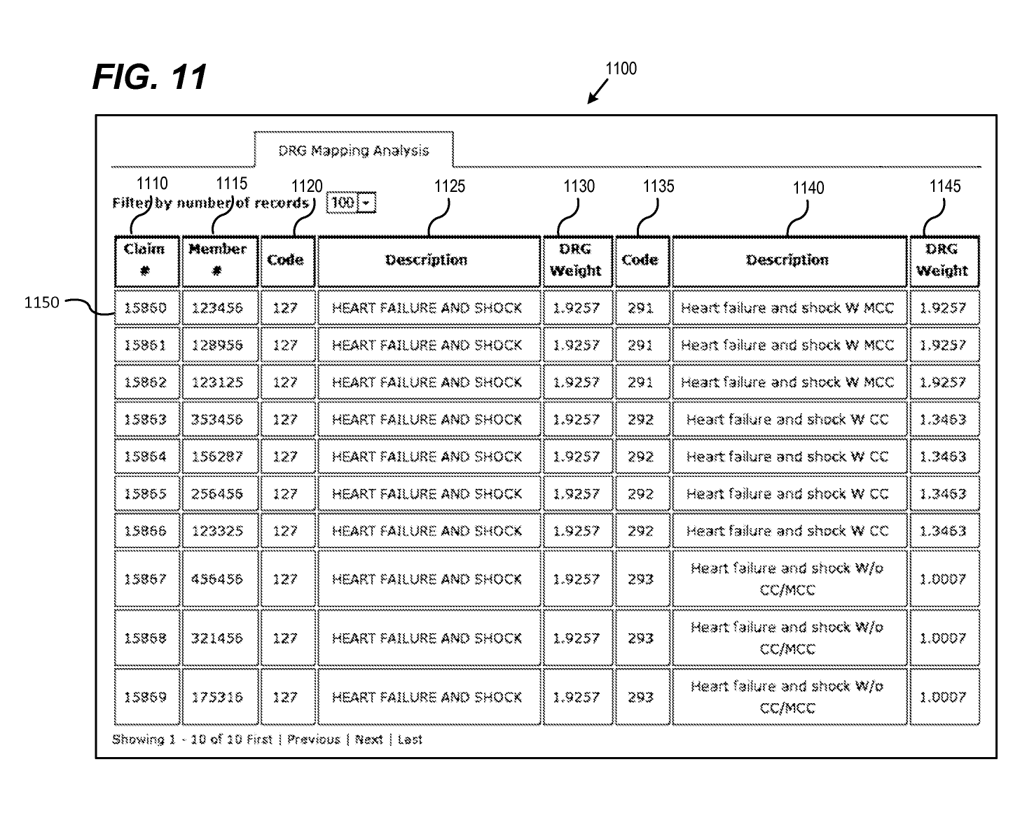

FIG. 11 illustrates an exemplary implementation of a DRG Mapping Analysis Report. The DRG Mapping Analysis Report provides information about the mapping of DRG codes encoded in a first DRG version to DRG codes encoded in a different DRG version for respective claims records processed in the medical-claims simulation generation. For example, the report can provide information about mapping DRG-9 codes to DRG-10 codes for the processed claim records. During the generation of the medical-claims simulation, medical claims data can be translated from a first DRG version to a second DRG version, and corresponding claim level DRG mapping can be shown in the DRG Mapping Analysis Report. The DRG Mapping Analysis Report can include fields that correspond to data entries for processed claim records. The fields of the DRG Mapping Analysis Report can include a claim number 1110, a member number 1115, a patient number, a DRG Code coded according to a first version of DRG 1120, a description of the DRG code coded according to the first version of DRG 1125, a weight for the DRG Code coded according to the first version of DRG 1130, a DRG Code coded according to a second version of DRG 1135, a description of the DRG code coded according to the second version of DRG 1140, and/or a weight for the DRG Code coded according to the second version of DRG 1145. The DRG Mapping Analysis Report can include one or more rows of data entries for processed claim records that correspond to the fields of the DRG Mapping Analysis Report. For example, at 1150 a row of data entries for a processed claim record is shown corresponding the data entries to the displayed fields of the DRG Mapping Analysis Report.

### EXAMPLE 17

### Exemplary International Classification of Disease Mapping Analysis Report

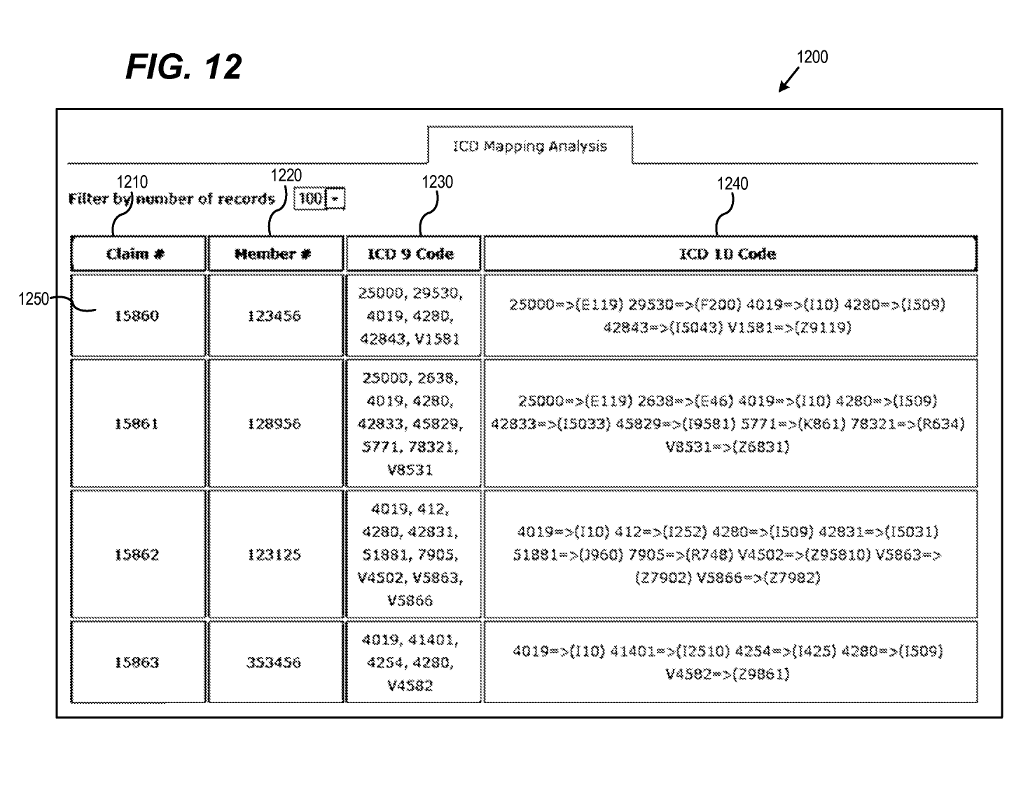

FIG. 12 illustrates an exemplary implementation of an International Classification of Disease (ICD) Mapping Analysis Report 1200. The ICD Mapping Analysis Report 1200 can display information about the mapping between codes of a first version of ICD to a different version of ICD for processed claim records. For example, a user can upload a medical claims data set and, in generation of a medical-claims simulation, data can be translated from ICD-9 to ICD-10 such that respective claim records are translated from ICD-9 codes to derive ICD-10 codes and the corresponding claim level ICD mapping can be shown in the ICD Mapping Analysis Report. The ICD Mapping Analysis Report can include fields that correspond to data entries corresponding to processed claim records. The ICD Mapping Analysis Report can include one or more fields for a claim identification number 1210, a member identification number 1220, a patient identification number, one or more ICD codes in a first version of ICD 1230, and/or one or more ICD codes in a second version of ICD 1240. The ICD Mapping Analysis Report can include one or more rows of data entries for processed claim records that correspond to the fields of the ICD Mapping Analysis Report. For example, a row of data entries 1250 for a processed claim record is shown corresponding the data entries to the displayed fields of the ICD Mapping Analysis Report.

### EXAMPLE 18

### Exemplary Composite Mapping Analysis Report

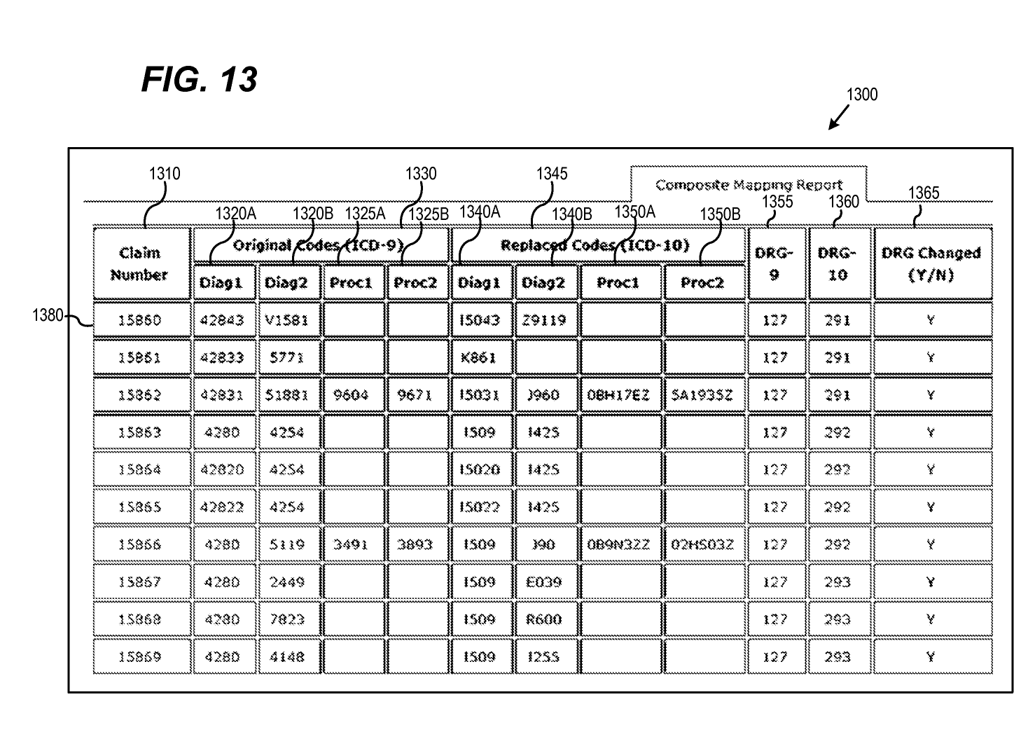

FIG. 13 illustrates an exemplary implementation of a Composite Mapping Analysis Report 1300. The Composite Mapping Analysis Report 1300 can display information about the mapping between ICD versions and between DRG versions for respective processed claim records. For example, a user can upload a medical claims data set and, in generation of a medical-claims simulation, data in claim records can be translated from ICD-9 codes to ICD-10 codes and appropriate DRG codes for respective claim records can be derived using DRG-9 and DRG-10. That is to say, respective claim records of the medical claims data set can be translated from ICD-9 codes to ICD-10 codes and corresponding claim record level DRG mapping can be displayed. The claim record level mapping can show the DRG codes for the claim records in the different versions of DRG. The Composite Mapping Analysis Report can include fields that correspond to data entries for processed claim records. The fields of the Composite Mapping Analysis Report can include one or more fields for a claim identification number 1310, one or more diagnosis codes in a first version of ICD 320A-B, one or more procedure codes under the first version of ICD 1325A-B, one or more diagnosis codes coded according to a second version of ICD 1340A-1340B, one or more procedure codes coded according to the second version of ICD 1350A-B, a DRG code coded according to a first version of DRG 1355, a DRG code coded according to a second version of DRG 1360, and/or a flag 1365 that indicates whether the DRG codes of the first and second DRG versions are different. The Composite Mapping Analysis Report can include one or more rows of data entries for processed claim records that correspond to the fields of the Composite Mapping Analysis Report. For example, a row of data entries 1380 for a processed claim record with a claim number of “15860” is shown corresponding the data entries to the displayed fields of the Composite Mapping Analysis Report.

### EXAMPLE 19

### Exemplary International Classification of Disease Level Payment Distribution Report

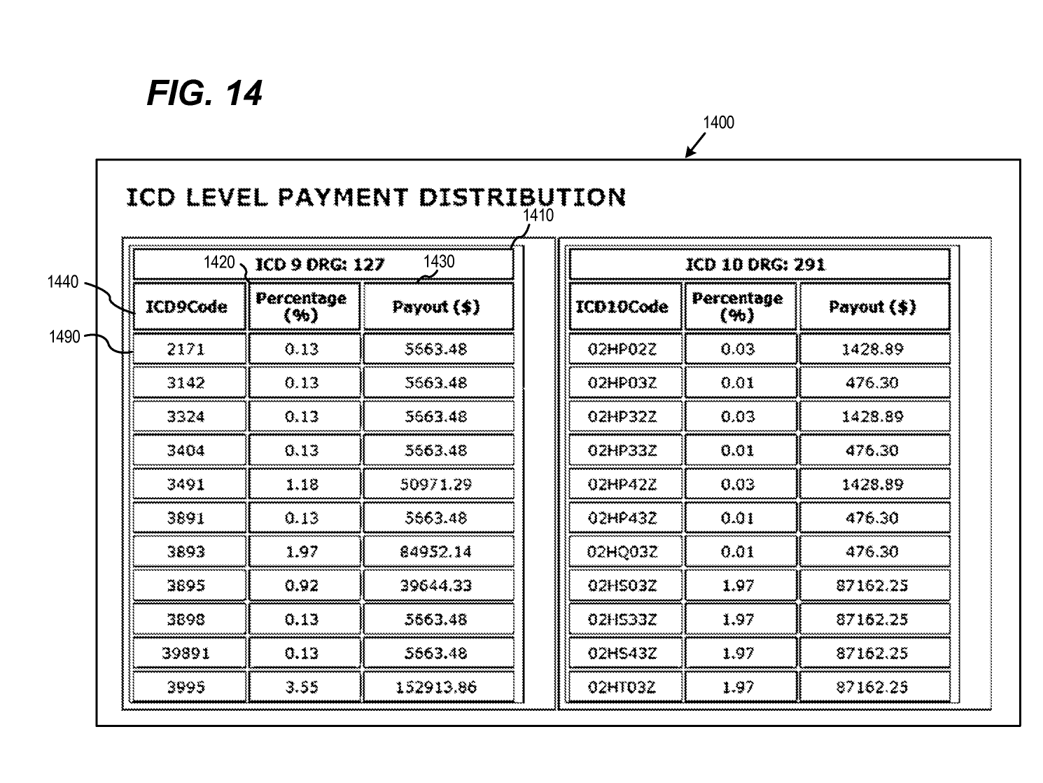

FIG. 14 illustrates an example International Classification of Diseases Level Payment Distribution Report 1400. The ICD Level Payment Distribution Report 1400 can include fields corresponding to a DRG code coded in a version of DRG such as shown at 1410. The ICD Level Payment Distribution Report can include fields for an ICD code in a version of ICD 1440, a percentage of the medical claim records that include the ICD code 1420, and a payout amount for the combined claim records that include the amount. The ICD Level Payment Distribution Report can include one or more rows of data entries that correspond to the fields of the ICD Level Payment Distribution Report. For example, a row of data entries 1490 is shown corresponding the data entries to the displayed fields of the ICD Level Payment Distribution Report.

### EXAMPLE 20

### Exemplary Major Diagnostic Categories Report

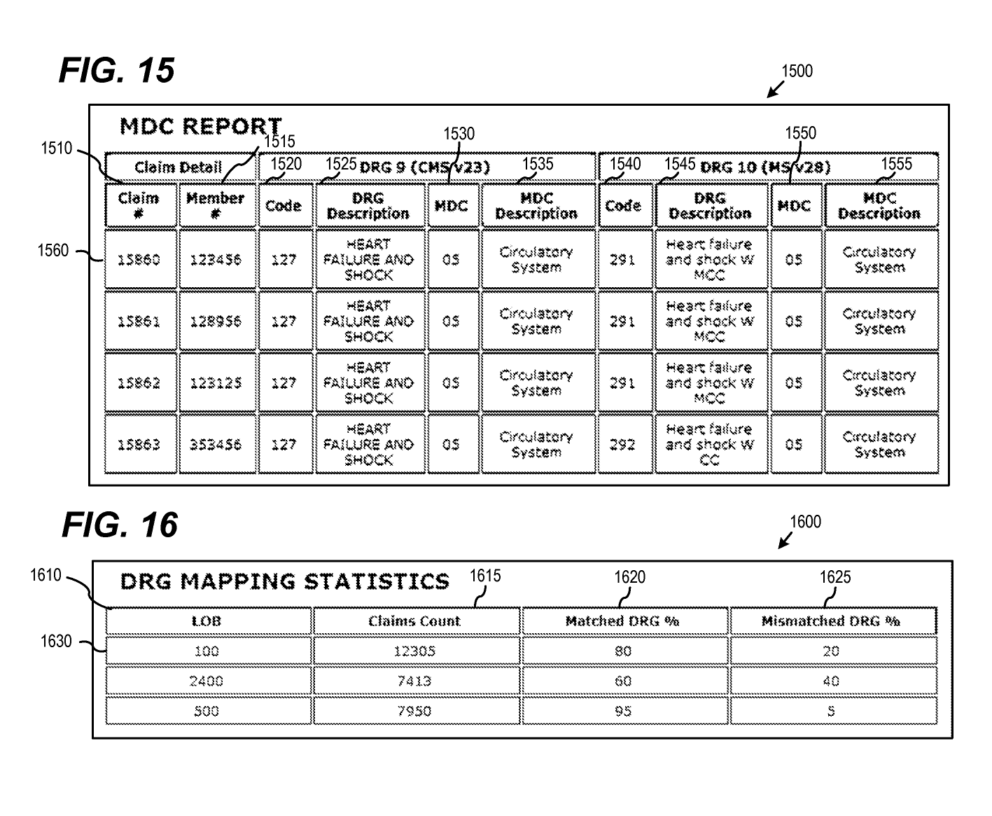

FIG. 15 illustrates an exemplary implementation of a Major Diagnostic Categories (MDC) Report 1500. The MDC Report 1500 displays information about mapping between different versions of MDC for respective processed claim records. For example, a user can upload a medical claims data set and, in generation of a medical-claims simulation, data in claim records can be translated from DRG-9 codes to DRG-10 codes and corresponding MDC-9 and MDC-10 codes appropriate for respective claim records can be derived from the DRG-9 and DRG-10 codes. That is to say, respective claim records can be translated from MDC version 9 to MCD version 10 and corresponding claim record level MDC mapping can be shown in the MDC Mapping Analysis report. The claim record level MDC mapping can show MDC codes appropriate for respective claim records coded in different versions of MCD. The MDC Report 1500 can include fields that correspond to data entries for processed claim records. The MDC Report 1500 can include fields for a claim number identifier, a member identification number, a patient identification number, a DRG code coded according to a first DRG version, an MDC code coded according to the first DRG version, a description of the MDC code coded according to the first DRG version, a DRG code coded according to a second DRG version, an MDC code coded according to the second DRG version, a description of the MDC code coded according to the second DRG version. The MDC Report 1500 can include one or more rows of data entries that correspond to the fields of the MDC Report 1500. For example, a row of data entries 1560 is shown corresponding the data entries to the displayed fields of the MDC Report 1500.

### EXAMPLE 21

### Exemplary Diagnosis-Related Group Mapping Statistics Report

FIG. 16 illustrates and exemplary implementation of a Diagnosis-Related Group (DRG) Mapping Statistics Report 1600. The DRG Mapping Statistics Report can display information about statistics on a DRG level. For example, a user can upload a medical claims data set and, in generation of a medical-claims simulation, data in claim records can be translated or mapped from ICD-9 codes to ICD-10 codes from which DRG codes can be derived. When the translation is completed the DRG Mapping Statistics Report can be generated using the analyzed medical claims data set. The DRG Mapping Statistics Report 1600 can include fields for a line of business 1610, a claim count 1615, a percent of matched DRG codes 1620, and/or a percent of mismatched DRG codes 1625. In one example implementation, because the medical claims data uploaded can include multiple client business lines, an entry in a line of business field can represent the contribution of respective lines of business and their corresponding data sets. Also for example, an entry in a claim count field can represent the total number of claims uploaded by the client against respective lines of business. In a further example, an entry in a field for a percent of matched DRG codes can indicate a percent of DRG codes in a first version of DRG (e.g., DRG-9) matched against DRG codes in a second version of DRG (e.g., DRG-10). In yet another example, an entry in a field for a percent of mismatched DRG codes can indicate a percent of DRG codes in a first version of DRG (e.g., DRG-9) not matched against codes in a second version (e.g., DRG-10).

### EXAMPLE 22

### Exemplary Database Design for Implementing a Combination of the Described Technologies

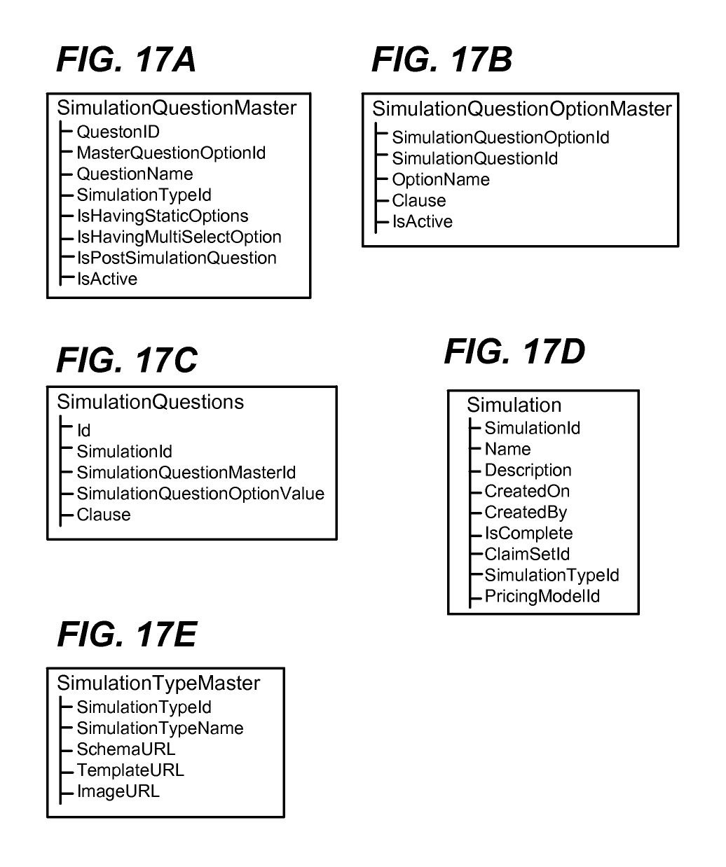

FIGS. 17A-E illustrate an exemplary database design for storing and using information collected and used in generating one or more medical-claims simulations. In other implementations, information for medical-claims simulation generation and outputting can be collected, stored, and retrieved using other data storing and retrieval methods. FIG. 17A illustrates a database table that implements a questionnaire prompt bank that stores questionnaire prompts for a simulation scenario. Entries for the columns in the database table are described in Table 1.

TABLE 1
Questionnaire Prompt Database Table

| Column | Entry Description |
|---|---|
| QuestionId | Identifier of a questionnaire prompt |
| MasterQuestionOptionId | An identifier of a questionnaire option |
| | that if selected causes the questionnaire |
| | prompt to be output |
| QuestionName | The questionnaire prompt that can be |
| | outputted |
| SimulationTypeId | Identifier of a simulation scenario |
| | associated with the questionnaire prompt |
| IsHavingStaticOptions | A flag indicating if the questionnaire |
| | prompt is associated with static |
| | questionnaire options |
| IsPostSimulationQuestion | A flag indicating if the questionnaire |
| | prompt is used in a dynamic questionnaire |
| | for filtering a generated medical-claims |
| | simulation |
| IsHavingMultiSelectOption | A flag indicating if multiple of the |
| | questionnaire options associated with |
| | the questionnaire prompt can be |
| | selected concurrently |
| IsActive | A flag indicating if the questionnaire |
| | prompt is active and available for outputting |

FIG. 17B illustrates a database table that implements a questionnaire option bank that can store questionnaire options for a simulation scenario. Entries for the columns in the database table are described in Table 2.

TABLE 2
Questionnaire Option Database Table

| Column | Entry Description |
|---|---|
| SimulationQuestionOptionId | Identifier of the simulation |
| | questionnaire option |
| SimulationQuestionId | An identifier of a questionnaire prompt |
| | that if output causes the questionnaire |
| | option to be output |
| OptionName | A value for the option if it is a static |
| | option or a template field for filtration |
| | if it is a dynamic option |
| Clause | The logic for setting a parameter if the |
| | questionnaire option is selected. |
| IsActive | A flag indicating if the questionnaire |
| | option is active and available for |
| | outputting |

FIG. 17C illustrates a database table that that can store information about questionnaire prompts outputted and questionnaire options selected for a dynamic questionnaire for a simulation scenario. Entries for the columns in the database table are described in Table 3.

TABLE 3
Questionnaire Results Database Table

| Column | Entry Description |
|---|---|
| Id | Identifier of the questionnaire |
| | results entry |
| SimulationId | Identifier of the associated simulation |
| | scenario for the dynamic questionnaire |
| SimulationQuestionMasterId | Identifier of an outputted questionnaire |
| | prompt |
| SimulationQuestionOptionValue | A selected questionnaire option value |
| Clause | The logic for setting a parameter |
| | associated with the selected |
| | questionnaire option |

FIG. 17D illustrates a database table that that can store information about generated medical-claims simulations. Entries for the columns in the database table are described in Table 4.

TABLE 4
Medical-Claims Simulation Database Table

| Column | Entry Description |
|---|---|
| SimulationId | Identifier number of a medical-claims simulation |
| Name | The name of the medical-claims simulation |
| Description | A description of the medical-claims simulation |
| CreatedOn | Date and time of creation of the |
| | medical-claims simulation |
| CreatedBy | Name of the medical-claims simulation creator |
| IsComplete | A flag indicating if the information for the |
| | medical-claims simulation is collected |
| ClaimSetId | A reference to a received medical claims data set |
| | used for generating the medical-claims simulation |
| SimulationTypeId | Indicates a simulation scenario used for generating the |
| | medical-claims simulation |
| ModelId | Indicates a pricing model used for generating |
| | the medical-claims simulation |

FIG. 17E illustrates a simulation scenario database table that that can store information about simulation scenarios and configuration information for respective simulation scenarios. Entries for the columns in the simulation scenario database table are described in Table 5.

TABLE 5
Simulation Scenario Database Table

| Column | Entry Description |
|---|---|
| SimulationTypeId | Numerical identifier of a simulation scenario |
| SimulationTypeName | Name of the simulation scenario |
| SchemaURL | A file location of a schema file used for claim |
| | validation for the simulation scenario |
| TemplateURL | The file location of a spreadsheet template |
| | used for the simulation scenario |
| ImageURL | The location of an image associated with |
| | the simulation scenario |

### EXAMPLE 23

### Example Questionnaire Options Bank

FIG. 18 illustrates an example implementation of a questionnaire options bank 1800. The questionnaire options bank 1800 is a database table that includes data included in rows of records associated with questionnaire options. The data included in the questionnaire options bank 1800 can be used to determine the dynamic questionnaire illustrated in FIG. 5. The questionnaire options bank 1800 includes table columns for a questionnaire option identifier 1820, a questionnaire prompt identifier 1825, a questionnaire option 1830, a logic for a simulation parameter 1835, and an active flag 1840.

### EXAMPLE 24

### Example Questionnaire Prompt Bank

FIG. 19 illustrates an example implementation of a questionnaire prompt bank 1900. The questionnaire prompt bank 1900 is a database table that includes data included in rows of records associated with questionnaire prompts. The questionnaire prompt bank 1900 can be used to determine the dynamic questionnaire illustrated in FIG. 5. The questionnaire prompt bank 1900 includes table columns for a questionnaire prompt identifier 1920, a questionnaire option identifier 1925, a questionnaire prompt 1930, a simulation scenario identifier 1935, a static options flag 1940, a dynamic options flag 1945, and an active flag 1950.

### EXAMPLE 25

### Example Questionnaire Results Bank

FIG. 20 illustrates an example implementation of a questionnaire results bank 2000. The questionnaire results bank 2000 is a database table that includes rows of data for records associated with questionnaire prompts output and questionnaire options selected for a dynamic questionnaire. The data stored in the questionnaire prompt bank 2000 can be generated by the dynamic questionnaire illustrated in FIG. 5. In one exemplary implementation, the data stored in the questionnaire results bank 2000 is used to generate a medical-claims simulation. For example, the data under the clause column can be used as parameters for generating a medical-claims simulation. For example, one or more of the parameters can be used to generate a database query to query a received medical claims data set for claim records that conform to the parameters set by the dynamic questionnaire. The conforming claim records can then be processed in the generation of a medical-claims simulation using some of the set parameters as well. For example, using the information from questionnaire prompt bank 2000, a query can be generated that returns conforming claim records that include a discharge date field that is not null, that indicate a male patient in a gender field, and that indicates the patient is older than 30 years of age as calculated from a data of birth field. The set of claim records returned from the query can be processed in the medical-claims simulation generation. Also for example, one or more or the parameters can be used to set a tool (e.g., mapper, grouper, or other tool) for generating a medical-claims simulation. The entry 2015 can be used to determine that the “GEMS” mapper tool is to be used to map between coding systems in medical-claims simulation generation. In other examples, one or more of the parameters can be used to determine other values for generating a medical-claims simulation. The questionnaire results bank 2000 includes table columns for a results entry identifier 2020, a medical-claims simulation identifier 2025, a questionnaire prompt identifier 2030, a selected questionnaire option value 2035, and a clause column 2040 for entries of logic for setting a parameter.

### EXAMPLE 26

### Exemplary Database Design

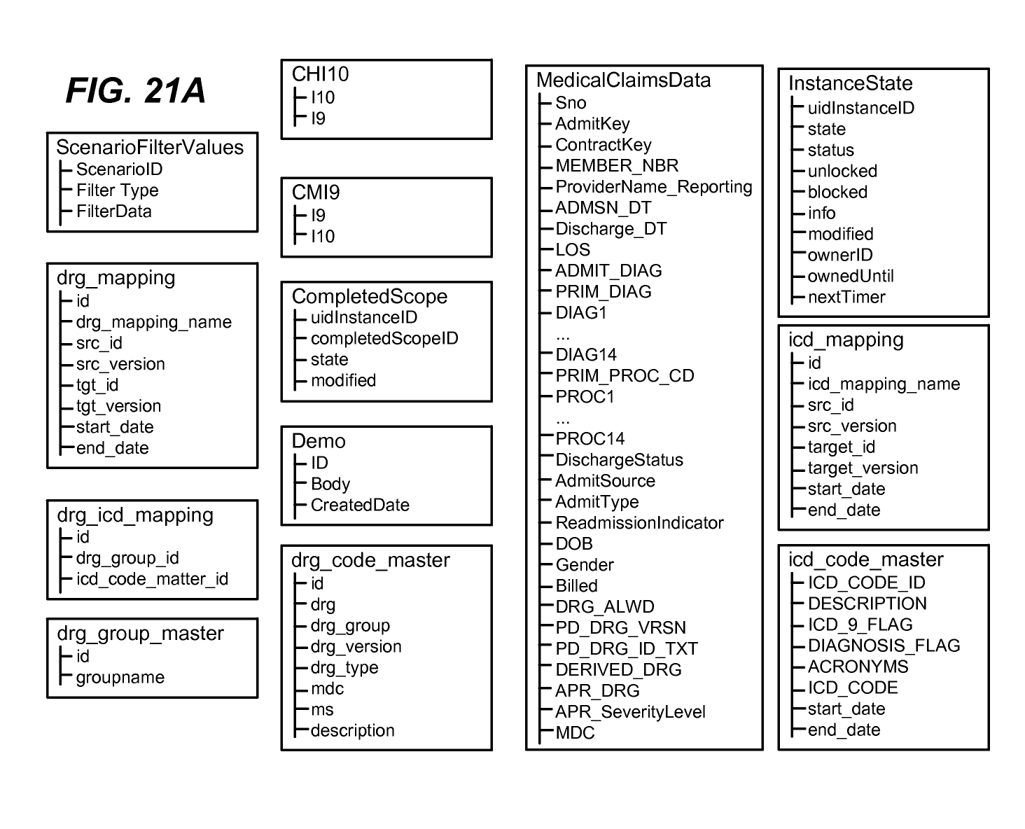

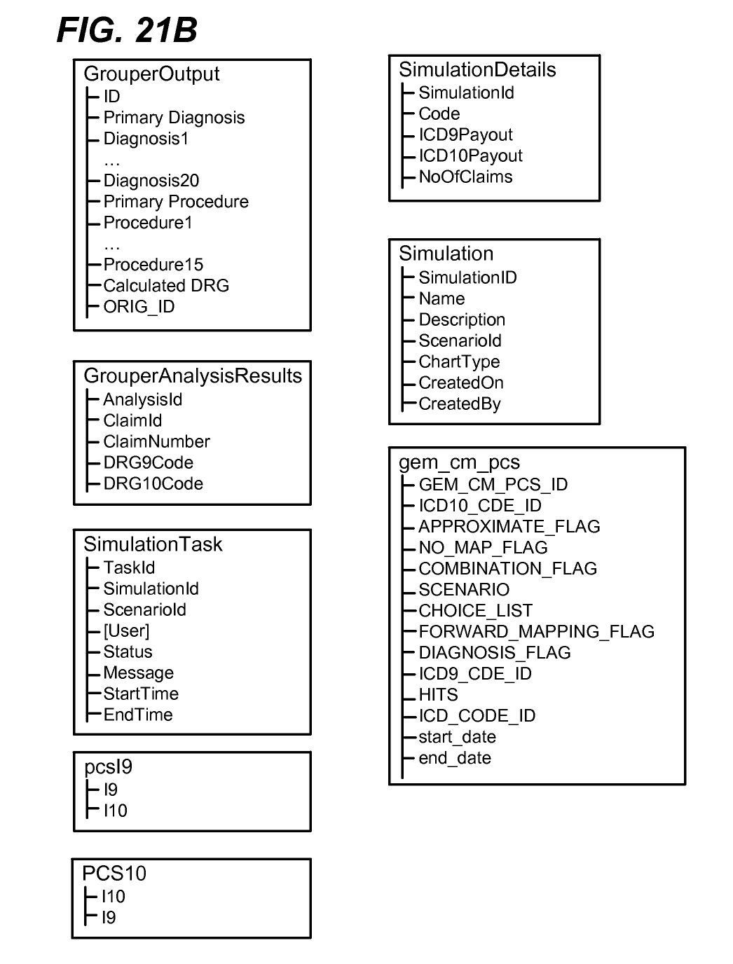

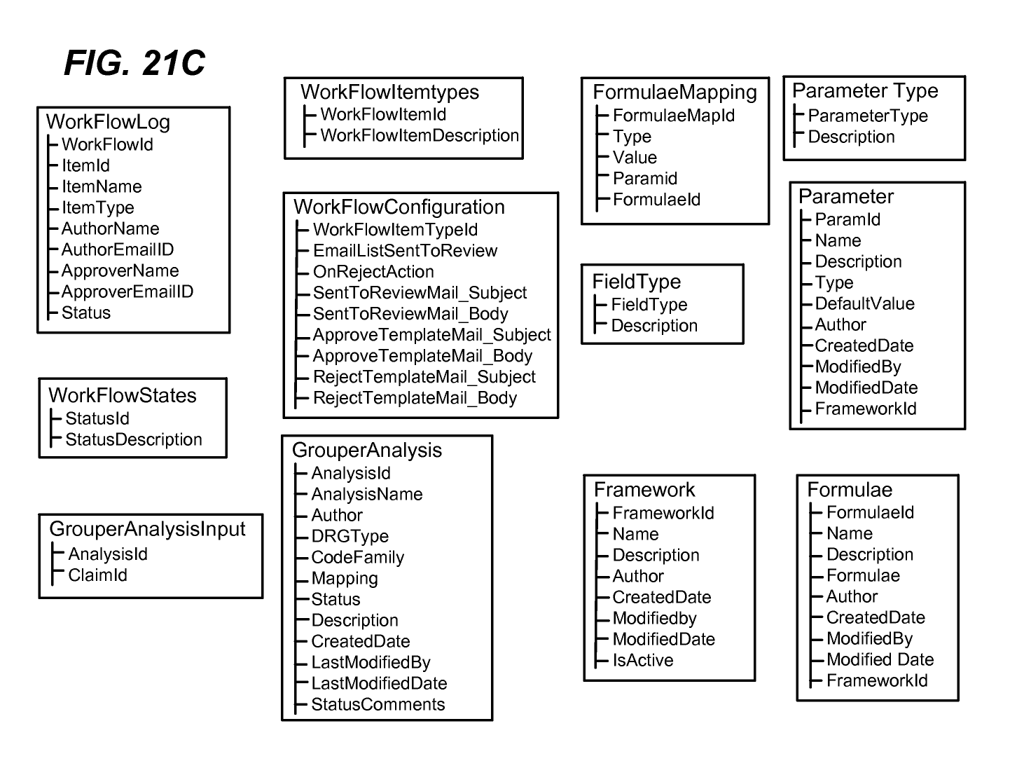

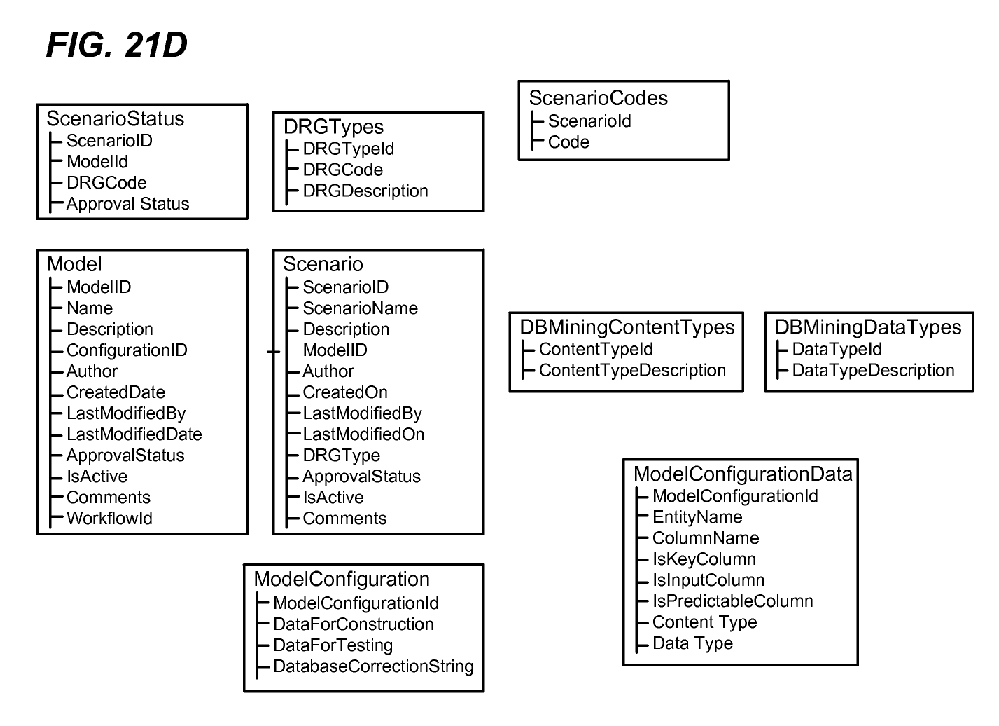

FIGS. 21A-D illustrate an exemplary design for a database for implementing one or more of the described technologies herein.

### EXAMPLE 27

### Exemplary Architecture

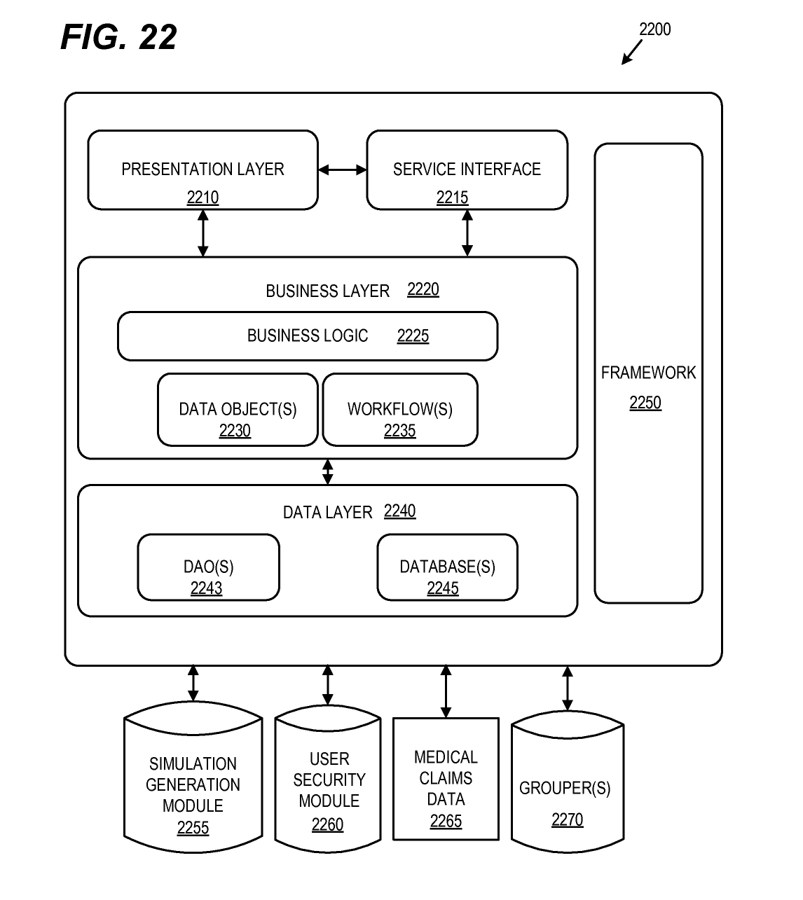

FIG. 22 is a schematic diagram of an exemplary architecture 2200 for implementing one or more of the described technologies. The architecture 2200 includes a presentation layer 2210. The presentation layer can generate a user interface. The user interface can be a web based interface and the presentation layer can be implemented using one or more web technologies (e.g., ASP.NET MVC 2). A user interface can be displayed to a user in a display screen using an application (e.g., web browser). The architecture 2200 includes a service interface 2215. The service interface 2215 can include service interface functionality and service hosting functionality. For example, a service interface can include one or more service contracts, one or more service implementations, and one or more data contracts. In one implementation, service contracts include a simulation service contract and a grouper analysis service contract. In another implementation, a service contract can be followed by a service implementation that can call the business logic layer 2220. In yet another implementation, the input and output of the service interface can be determined by a data contract or a message contract. In another implementation of the service interface 2215, the service interface 2215 is implemented as a web service (e.g., WCF Web Service using HTTP basicHttpBinding) and a hosted service (e.g., a WCF Service) that is hosted (e.g., in a Windows-based service as HTTP or NET/TCP basicHttpBinding or netTcpBinding). In one implementation of the architecture, the service hosting moves long running processes to use a service. For example, long running processes (e.g., using databases, or analytics) such as medical-claims simulation generation and grouper analysis can be handled by services that are hosted. The architecture 2200 includes a business layer 2220. The business layer 2220 includes a business logic 2225, one or more workflows 2235, and one or more data objects 2230. The architecture 2200 also includes a data layer 2240 that includes one or more data access objects 2243, and one or more databases 2245. Also, the architecture 2200 includes a framework 2250. The architecture 2200 includes a simulation generation module 2255 that can generate a medical-claims simulation. The architecture 2200 also includes a user security module 2260, received medical claims data 2265, and one or more groupers 2270. The architecture can be implemented on one or more computing systems. In some exemplary implementations, a web server, and a web service used to implement the architecture 2200 can be running on the same or separate computing systems, and a database server used can also be on a same or separate computing system.

### EXAMPLE 28

### Exemplary Computing System

The techniques and solutions described herein can be performed by software and/or hardware of a computing environment, such as a computing device. For example, computing devices include server computers, desktop computers, laptop computers, notebook computers, netbooks, tablet devices, mobile devices, and other types of computing devices (e.g., devices such as televisions, media players, or other types of entertainment devices that comprise computing capabilities such as audio/video streaming capabilities and/or network access capabilities). The techniques and solutions described herein can be performed in a cloud computing environment (e.g., comprising virtual machines and underlying infrastructure resources).

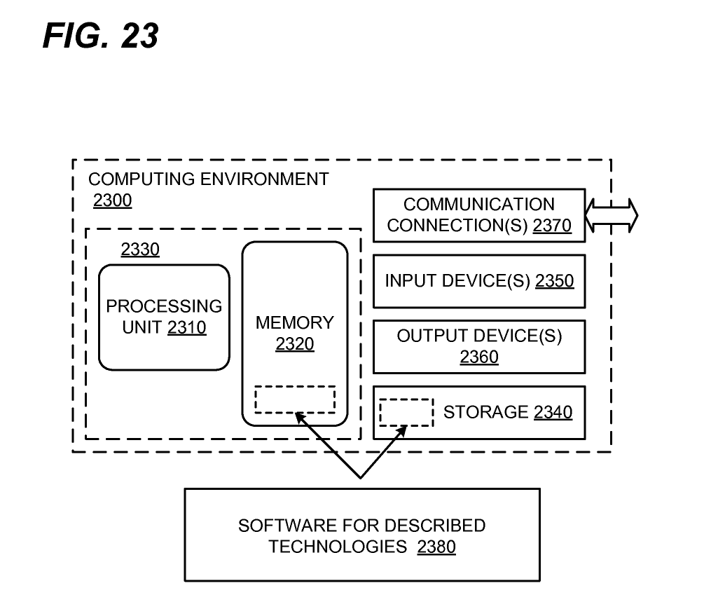

FIG. 23 illustrates a generalized example of a suitable computing environment 2300 in which described embodiments, techniques, and technologies may be implemented. The computing environment 2300 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, or the like. The disclosed technology may also be practiced in distributed computing environments where tasks are performed by remote processing devices that are linked through a communications network. In a distributed computing environment, program modules may be located in both local and remote memory storage devices.

With reference to FIG. 23, the computing environment 2300 includes at least one central processing unit 2310 and memory 2320. In FIG. 23, this most basic configuration 2330 is included within a dashed line. The central processing unit 2310 executes computer-executable instructions. In a multi-processing system, multiple processing units execute computer-executable instructions to increase processing power and as such, multiple processors can be running simultaneously. The memory 2320 may be volatile memory (e.g., registers, cache, RAM), non-volatile memory (e.g., ROM, EEPROM, flash memory, etc.), or some combination of the two. The memory 2320 stores software 2380 that can, for example, implement one or more of the technologies described herein. A computing environment may have additional features. For example, the computing environment 2300 includes storage 2340, one or more input devices 2350, one or more output devices 2360, and one or more communication connections 2370. An interconnection mechanism (not shown) such as a bus, a controller, or a network, interconnects the components of the computing environment 2300. Typically, operating system software (not shown) provides an operating environment for other software executing in the computing environment 2300, and coordinates activities of the components of the computing environment 2300.

The storage 2340 may be removable or non-removable, and includes magnetic disks, magnetic tapes or cassettes, CD-ROMs, CD-RWs, DVDs, or any other tangible storage medium which can be used to store information and which can be accessed within the computing environment 2300. The storage 2340 stores computer-executable instructions for the software 2380, which can implement technologies described herein.

The input device(s) 2350 may be a touch input device, such as a keyboard, keypad, mouse, pen, or trackball, a voice input device, a scanning device, or another device, that provides input to the computing environment 2300. For audio, the input device(s) 2350 may be a sound card or similar device that accepts audio input in analog or digital form, or a CD-ROM reader that provides audio samples to the computing environment 2300. The output device(s) 2360 may be a display, printer, speaker, CD-writer, or another device that provides output from the computing environment 2300.

The communication connection(s) 2370 enable communication over a communication medium (e.g., a connecting network) to another computing entity. The communication medium conveys information such as computer-executable instructions, compressed graphics information, or other data in a modulated data signal.

### EXAMPLE 29

### Exemplary Alternatives and Variations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable media (tangible computer-readable storage media, such as one or more optical media discs, volatile memory components (such as DRAM or SRAM), or nonvolatile memory components (such as hard drives)) and executed on a computing device (e.g., any commercially available computer, including smart phones or other mobile devices that include computing hardware). By way of example, computer-readable media include memory 2320 and/or storage 2340. As should be readily understood, the term computer-readable media does not include communication connections (e.g., 2370) such as modulated data signals.

Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to a particular type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed towards all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method implemented at least in part by a computing device, the method comprising:
receiving medical claims data coded in part according to at least one coding system;
outputting at least one dynamic questionnaire comprising questionnaire options;
receiving at least one selection of the questionnaire options; and
based at least on the medical claims data and the at least one selection of the questionnaire options, generating at least one medical-claims simulation.

2. The method of claim 1 wherein the generating the at least one medical-claims simulation comprises:
determining simulation claims data using the medical claims data, wherein the simulation claims data comprises a code that is coded according to a different coding system than the at least one coding system, and
wherein the code is derived from the medical claims data coded in part according to the at least one coding system.

3. The method of claim 2 wherein the at least one coding system comprises an International Classification of Diseases version; and
wherein the different coding system is an International Classification of Diseases version, a Diagnosis-Related Group version, or a Major Diagnostic Categories version.

4. The method of claim 1, wherein the at least one medical-claims simulation comprises a Payment Analysis Report, a Diagnosis-Related Group Mapping Analysis Report, an International Classification of Diseases (ICD) Mapping Analysis Report, a Composite Mapping Analysis Report, a Major Diagnostic Categories Report, a Diagnosis-Related Group Mapping Statistics Report, or an International Classification of Diseases Level Payment Distribution Report.

5. The method of claim 1 wherein the selections of the questionnaire options set one or more parameters; and
wherein the generating the at least one coding system comprises using the one or more parameters to determine a mapper, a grouper, a coding system, or a claim record to be used in the generating the at least one medical-claims simulation.

6. The method of claim 1 further comprising:
receiving at least one simulation scenario selection; and
wherein the outputting the at least one dynamic questionnaire is based at least on the at least one simulation scenario selection.

7. The method of claim 1 further comprising:
based at least on the at least one selection of the questionnaire options, outputting a questionnaire prompt and additional questionnaire options;
receiving at least one selection of the additional questionnaire options; and
wherein the generating the at least one medical-claims simulation is further based at least on the at least one selection of the additional questionnaire options.

8. The method of claim 1 wherein the dynamic questionnaire further comprises a questionnaire prompt associated with the questionnaire options.

9. The method of claim 1 further comprising validating the medical claims data.

10. The method of claim 1 further comprising receiving a selection of a pricing model; and
wherein the generating the at least one medical-claims simulation comprises using the pricing model, the using the pricing model comprises deriving a payment amount using a Diagnosis-Related Group code or an International Classification of Diseases code.

11. The method of claim 1 further comprising:
based on the at least one medical-claims simulation, outputting simulation questionnaire options;
receiving at least one selection of the simulation questionnaire options; and
based on the at least one selection of the simulation questionnaire options, generating at least one filtered medical-claims simulation.

12. The method of claim 1, wherein the medical claims data is organized according to a predetermined template.

13. A computing system comprising a processor and a memory, the memory storing computer-executable instructions that when executed cause the computing system to perform a method, the method comprising:
receiving medical claims data coded in part according to at least one coding system;
based at least on the medical claims data, outputting at least one dynamic questionnaire comprising questionnaire options;
receiving at least one selection of the questionnaire options; and
based at least on the medical claims data and the at least one selection of the questionnaire options, generating at least one medical-claims simulation.

14. The computing system of claim 13, wherein the generating the at least one medical-claims simulation comprises:
determining simulation claims data using the medical claims data, wherein the simulation claims data comprises a code that is coded according to a different coding system; and
wherein the code is derived from the medical claims data coded in part according to the at least one coding system.

15. The computing system of claim 14, wherein the at least one coding system comprises a Diagnosis-Related Group version; and
wherein the different coding system is an International Classification of Diseases version, a Diagnosis-Related Group version, or a Major Diagnostic Categories version.

16. The computing system of claim 13 further comprising:
based at least on the at least one selection of the questionnaire options, outputting additional questionnaire options;
receiving at least one selection of the additional questionnaire options; and
wherein the generating the at least one medical-claims simulation is further based at least on the at least one selection of the additional questionnaire options.

17. The computing system of claim 13 wherein the questionnaire further comprises a questionnaire prompt corresponding to the questionnaire options.

18. The computing system of claim 13 further comprising:
based on the at least one medical-claims simulation, outputting simulation questionnaire options;
receiving at least one selection of the simulation questionnaire options; and
based on the at least one selection of the simulation questionnaire options, generating at least one filtered medical-claims simulation.

19. The computing system of claim 13, wherein the medical-claims simulation comprises a Payment Analysis Report, a Diagnosis-Related Group Mapping Analysis Report, an International Classification of Diseases (ICD) Mapping Analysis Report, a Composite Mapping Analysis Report, a Major Diagnostic Categories Report, a Diagnosis-Related Group Mapping Statistics Report, or an International Classification of Diseases Level Payment Distribution Report.

20. One or more computer readable media storing computer-executable instructions that when executed cause a computing device to perform a method, the method comprising:
receiving at least one simulation scenario selection;
receiving medical claims data coded in part according to at least a first coding system, the medical claims data organized according to a predetermined template;
validating the medical claims data;
based at least on the at least one simulation scenario selection, outputting a dynamic questionnaire comprising first questionnaire options;
receiving one or more selections of the first questionnaire options;
based on the one or more selections of the first questionnaire options, outputting a questionnaire prompt and second questionnaire options;
receiving one or more selections of the second questionnaire options;
receiving a selection of a pricing model; and
based at least on the medical claims data and the one or more selections of the first and second questionnaire options, generating at least one medical-claims simulation, wherein the generating the at least one medical-claims simulation comprises determining simulation medical claims data from the medical claims data, wherein the simulation medical claims data is coded in part according to a second coding system.
